(19) United States
(12) Patent Application Publication
(10) Pub. No.: US 2016/0347885 A1
(43) Pub. Date: Dec. 1, 2016

(54) SYSTEMS AND PROCESSES FOR MAKING A POLY(VINYL ACETAL) RESIN WITH ENHANCED PARTICLE TRANSPORT AND RECOVERY

(71) Applicant: SOLUTIA INC., St. Louis, MO (US)

(72) Inventors: KENNY PARKER, Afton, TN (US); Pol D'Haene, Kessel-lo (BE); Nandan Ukidwe, Suffield, CT (US)

(73) Assignee: SOLUTIA INC., St. Louis, MO (US)

(21) Appl. No.: 14/725,933

(22) Filed: May 29, 2015

(51) Int. Cl. C08F 116/38; B01J 19/24

(52) U.S. Cl. CPC C08F 116/38; B01J 19/24; B01J 2219/24

(57) ABSTRACT

Processes and systems for making a poly(vinyl acetal) resin particles are provided. The processes and systems described herein utilize one or more methods, including, for example, slurry dilution and/or filtration of various process streams, to optimize the transport and recovery of the poly(vinyl acetal) resin particles. Systems and processes described herein facilitate increased production of the final resin product by minimizing product loss and maximizing on-line operation time and production flexibility.

### BACKGROUND

1. Field of the Invention

The present invention relates generally to polymer resins and methods of making the same. In particular, this invention relates to systems and processes for making poly(vinyl acetal) resins, including those suitable for use in various types of polymer layers and interlayers.

2. Description of Related Art

Poly(vinyl butyral) (PVB) is often used in the manufacture of polymer sheets that can be used as interlayers in multiple layer panels, including, for example, light-transmitting laminated panels such as safety glass or polymeric laminates. PVB is also used in photovoltaic solar panels to encapsulate the panels which are used to generate and supply electricity for commercial and residential applications.

Safety glass generally refers to a transparent laminate that includes at least one polymer sheet, or interlayer, disposed between two sheets of glass. Safety glass is often used as a transparent barrier in architectural and automotive applications, and its primary functions are to absorb energy resulting from impact or a blow without allowing penetration of the object through the glass and to keep the glass bonded even when the applied force is sufficient to break the glass. This prevents dispersion of sharp glass shards, which minimizes injury and damage to people or objects within an enclosed area. Safety glass may also provide other benefits, such as a reduction in ultraviolet (UV) and/or infrared (IR) radiation, and it may also enhance the aesthetic appearance of window openings through addition of color, texture, and the like. Additionally, safety glass with desirable acoustic properties has also been produced, which results in quieter internal spaces.

PVB and other poly(vinyl acetal) resins are produced by reacting a poly(vinyl alcohol) with at least one aldehyde. As the resin precipitates out of solution during the reaction, catalyst and other impurities can become trapped in the resin particles. The presence of these impurities may adversely impact the appearance and/or performance of the resin during subsequent production and/or use.

Therefore, a need exists for a method of producing poly(vinyl acetal) resins that reduces impurities in the file product, while simultaneously minimizing product loss and/or maximizing production time and yield.

### SUMMARY

One embodiment of the present invention concerns a process for producing a poly(vinyl acetal) resin. The process comprises the steps of reacting a poly(vinyl alcohol) with at least one aldehyde to produce a reaction slurry comprising a plurality of poly(vinyl acetal) resin particles, contacting at least a portion of the poly(vinyl acetal) resin particles with a wash liquid to thereby provide a plurality of washed particles and a spent wash liquid, withdrawing at least a portion of the washed particles and spent wash liquid from the wash vessel as a solids-containing slurry, passing a portion of the solids-containing slurry through at least one filtration device to thereby provide a solids-enriched retentate stream and a solids-depleted permeate stream, and reintroducing at least a portion of the solids-enriched retentate stream back into the process at a location at or downstream of the contacting step. The passing increases the concentration of solids in the solids-enriched retentate stream as compared to the solids content of the solids-containing slurry introduced into the filtration device.

Another embodiment of the present invention concerns a process for producing a poly(vinyl acetal) resin. The process comprises the steps of introducing a reaction slurry comprising a plurality of poly(vinyl acetal) resin particles into a wash vessel, contacting at least a portion of the poly(vinyl acetal) resin particles in the wash vessel via contact with at least one wash liquid, removing a solids-containing slurry from the wash vessel, passing at least a portion of the solids-containing slurry through at least one filtration element to provide a solids-enriched stream and a solids-depleted stream, and recovering at least a portion of the poly(vinyl acetal) resin solids in the solids-enriched stream.

Yet another embodiment of the present invention concerns a system for producing a poly(vinyl acetal) resin. The system comprises a reaction vessel for reacting a poly(vinyl alcohol) and at least one aldehyde to form a reaction slurry comprising solid poly(vinyl acetal) resin particles. The reaction vessel comprises at least one reactor inlet and at least one reactor outlet. The system comprises a wash vessel for receiving at least a portion of the reaction slurry from the reaction vessel and for contacting at least a portion of the poly(vinyl acetal) resin particles with a wash liquid. The wash vessel comprises a slurry inlet, a slurry outlet, a wash fluid inlet, and a wash fluid outlet. The system comprises a wash liquid line for introducing the wash liquid into the wash vessel. The wash liquid line is in fluid flow communication with the wash fluid inlet of the wash vessel. The system comprises a washed slurry line for removing at least a portion of the solids-containing washed slurry from the wash vessel. The washed slurry line is in fluid flow communication with the slurry outlet of the wash vessel. The system comprises at least one filtration device external to the wash vessel for removing at least a portion of the poly(vinyl acetal) resin particles from the washed slurry. The filter element comprises a fluid inlet, a solids-enriched fluid outlet, a solids-depleted fluid outlet, and at least one filter surface. The fluid inlet of the filtration device is in fluid flow communication with the slurry outlet of the wash vessel via the washed slurry line. The filter surface is disposed between the fluid inlet and the solids-depleted fluid outlet within the filtration device and the filter surface is oriented generally parallel to the direction of flow of the washed slurry as it passes from the fluid inlet to the solids-enriched fluid outlet in the filtration device.

### BRIEF DESCRIPTION OF THE DRAWINGS

Various embodiments of the present invention are described in detail below with reference to the attached drawing Figures, wherein:

FIG. 1 is a schematic depiction of the main process zones in a facility for producing poly(vinyl acetal) resin configured according to one or more embodiments of the present invention;

FIG. 2 is side view of a reaction zone, separation zone, and external filtration device suitable for use in the production facility illustrated in FIG. 1;

FIG. 3a is a top cut-away view of a wash vessel configured according to one or more embodiments of the present invention, particularly illustrating use of screen filters as internal filtration devices;

FIG. 3b is a partial side cut-away view of the wash vessel illustrated in FIG. 3a;

FIG. 3c is a top cut-away view of a wash vessel configured according to one or more embodiments of the present invention, particularly illustrating use of candle filters as internal filtration devices;

FIG. 3d is a partial side cut-away view of the wash vessel illustrated in FIG. 3c;

FIG. 4a is a diagram illustrating what is meant by the term “circumferentially spaced,” particularly as it relates to internal filtration devices;

FIG. 4b is a diagram illustrating what is meant by the term “radially spaced,” particularly as it relates to internal filtration devices;

FIG. 4c is a diagram illustrating what is meant by the term “vertically spaced,” particularly as it relates to internal filtration devices;

FIG. 5 is a side view of an external filtration device configured according to one or more embodiments of the present invention;

FIG. 6 is a schematic diagram illustrating an filtration apparatus used to carry out the experimental procedure described in Example 1;

FIG. 7 is a graph of the permeate flux across the filter surface in the apparatus depicted in FIG. 6 for several trial runs described in Example 1;

FIG. 8a is a graph illustrating several process parameters for a comparative poly(vinyl acetal) resin process described in Example 3, particularly illustrating operation of a system without in-line dilution; and

FIG. 8b is a graph illustrating several process parameters for a disclosed poly(vinyl acetal) resin process described in Example 3, particularly illustrating operation of a system with in-line dilution.

### DETAILED DESCRIPTION

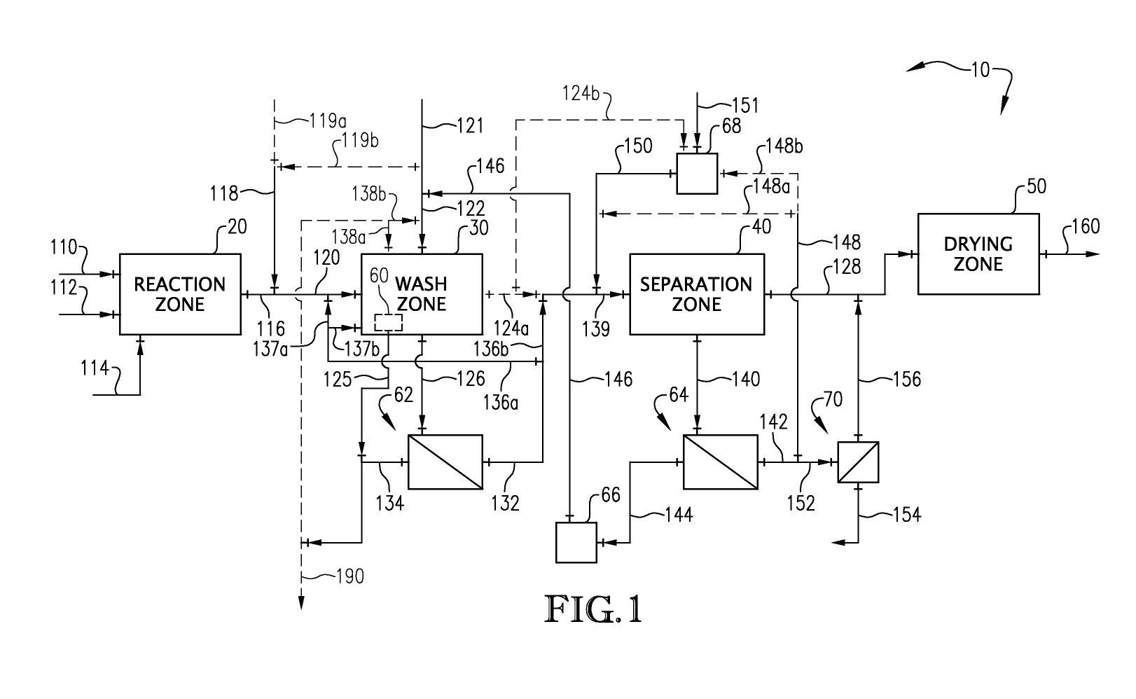

Referring initially to FIG. 1, a schematic diagram outlining the major processing zones of a poly(vinyl acetal) resin production facility 10, configured according to one or more embodiments of the present invention, is provided. As shown in FIG. 1, facility 10 includes a reaction zone 20, a wash zone 30, a separation zone 40, and a drying zone 50. Reactants, which typically include at least one poly(vinyl alcohol) and at least one aldehyde, are introduced into reaction zone 20, along with a catalyst, and are reacted to form a slurry including a plurality of solid poly(vinyl acetal) resin particles. The slurry is introduced into wash zone 30, wherein at least a portion of the particles are contacted with a wash liquid to remove contaminants and to further cool the slurry. The resulting cooled washed particle slurry is then introduced into separation zone 40, wherein additional liquid is removed. The resulting solids-rich material can then be further dried in drying zone 50 to provide a plurality of dried resin particles. As shown in FIG. 1, spent wash liquid withdrawn from wash zone 30 and/or separation zone 40 may be filtered with one or more internal or external filtration devices in order to remove any residual solids. As shown in FIG. 1, one or more of the resulting solids-depleted and/or solids-enhanced streams can then be returned to one or more locations within the facility, upstream or downstream of the withdrawal point, for further recovery and/or use.

Although generally described herein with respect to the production and recovery of particles of poly(vinyl acetal) resin, it should also be understood that the systems and methods according to embodiments of the present invention can be utilized when producing one or more other types of polymers. For example, in some embodiments, the systems and processes described herein may be used to produce one or more thermoplastic polymers, such as, for example, polyurethanes (PU), poly(ethylene-co-vinyl) acetates (EVA), polyvinyl chlorides (PVC), poly(vinylchloride-co-methacrylate), polyethylenes, polyolefins, ethylene acrylate ester copolymers, poly(ethylene-co-butyl acrylate), silicone elastomers, epoxy resins, polyvinyl alcohols, polyvinyl acetates, poly(arylene sulfides), cellulose esters, and acid copolymers such as ethylene/carboxylic acid copoloymers and ionomers thereof, derived from any of the previously-listed polymers, and combinations thereof.

When facility 10 is used to produce particles of a poly(vinyl acetal) resin, two or more reaction components, such as, for example, an aldehyde and a poly(vinyl alcohol), may be added to a polymerization reactor (not shown) in reaction zone 20 via conduits 110 and 112, as shown in FIG. 1. In some embodiments, at least one catalyst, such as, for example, an acid catalyst, may also be added to reaction zone 20 via conduit 114, as shown in FIG. 1. Although shown in separate conduits 110, 112, and 114, one or more of the reaction components introduced into reaction zone 20 may be combined prior to entering the reaction zone, or one or more of the components may be added separately. Additionally, the components may be added in any suitable order, or two or more may be added simultaneously. Further, one or more of the components may be combined with or dissolved in one or more solvents including, but not limited to, water or another aqueous solvent, prior to, or within, reaction zone 20.

The aldehyde in conduit 112 can be any suitable aromatic or aliphatic aldehyde and, in some embodiments, may comprise at least one C₁ to C₁₀ aldehyde or at least one C₄ to C₈ aldehyde. The aldehyde may be introduced alone as a single aldehyde component, or may be combined with one or more other aldehydes before introduction into, or within, reaction zone 20. Examples of suitable C₄ to C₈ aldehydes can include, but are not limited to, n-butyraldehyde, iso-butyraldehyde, 2-methylvaleraldehyde, n-hexyl aldehyde, 2-ethylhexyl aldehyde, n-octyl aldehyde, and combinations thereof. In some embodiments, the aldehyde component may be selected from the group consisting of n-butyraldehyde, iso-butyraldehyde, 2-methylvaleraldehyde, 2-ethylhexyl aldehyde, and combinations thereof. In other embodiments, the aldehyde in conduit 112 can comprise one or more other aldehydes including, but not limited to, cinnamaldehyde, hexylcinnamaldehyde, benzaldehyde, hydrocinnamaldehyde, 4-chlorobenzaldehyde, 4-t-butylphenylacetaldehyde, propionaldehyde, 2-phenylpropionaldehyde, and combinations thereof.

In some embodiments, the aldehyde concentration of the stream in conduit 112 can be at least about 90, at least about 95, at least about 97, at least about 99 weight percent, based on the total weight of the stream in conduit 112. In some embodiments, the aldehyde concentration in the stream in conduit 112 can be in the range of from about 90 to about 99.9, about 95 to about 99, or about 99 to about 99.9 weight percent, with the balance being one or more other aldehydes or other impurities. In some embodiments, the concentration of poly(vinyl) alcohol in the reactant stream in conduit 110 can be at least about 5, at least about 8, at least about 10 weight percent and/or not more than about 30, not more than about 20, not more than about 18, or not more than about 15 weight percent, based on the total weight of the stream in conduit 110, with the balance being water or other solvent. The concentration of the poly(vinyl alcohol), or “varnish,” in conduit 110 can be in the range of from about 5 to about 30, about 8 to about 20, or about 10 to about 18 weight percent, based on the total weight of the stream. The weight ratio of aldehyde in stream 112 to poly(vinyl alcohol) in stream 110 added to reaction zone 20 can be at least about 0.10:1, at least about 0.25:1, at least about 0.50:1 and/or not more than about 2:1, not more than about 1.5:1, or not more than about 0.75:1, or it can be in the range of from about 0.25:1 to about 1.5:1 or about 0.5:1 to about 0.75:1.

In reaction zone 20, the temperature of the reaction can be at least about 5, at least about 10, at least about 15, at least about 25, at least about 40, at least about 45, at least about 50, at least about 55, at least about 60, at least about 65, at least about 70, at least about 75, at least about 80 and/or not more than about 105, not more than about 100, not more than about 95, or not more than about 90° C., or in the range of from about 5 to about 105° C., from about 25 to about 100° C., from about 40 to about 95° C., or from about 50 to about 90° C. The reaction pressure can be at or near atmospheric pressure, and the residence time or average residence time may be varied as needed. Details for various other parameters of the reaction are described in U.S. Pat. Nos. 2,282,057 and 2,282,026 and in Vinyl Acetal Polymers, in Encyclopedia of Polymer Science & Technology, 3^{rd} edition, Volume 8, pages 381-399, by B. E. Wade (2003), the entire disclosures of which are incorporated herein by reference to the extent not inconsistent with the present disclosure.

In some embodiments, the reaction performed in reaction zone 20 may be a batch reaction, while, in other embodiments, it can be semi-batch or continuous. Further, the reaction may take place in a single reaction vessel, or it may be performed in two or more reaction vessels arranged in parallel or in series. The contents of the reactor may be agitated during the reaction and, in some embodiments, the reactor can be a continuous stirred tank reactor including at least one mechanical agitator. In some embodiments, the reactor may employ a high shear mixer as described in U.S. Patent Application No. 2010/0267921, the entirety of which is incorporated by reference to the extent not inconsistent with the present disclosure.

Upon reaction of the poly(vinyl alcohol) and aldehyde in reaction zone 20, the poly(vinyl acetal) resin particles precipitate out of solution and form a reaction slurry. As shown in FIG. 1, a stream of reaction slurry may be withdrawn from reaction zone 20 and passed to wash zone 30 via transfer conduit 116. In some embodiments, the particle slurry withdrawn from reaction zone 20 can have a total solids content, on a dry weight basis, of at least about 5, at least about 8, at least about 10, at least about 12 and/or not more than about 30, not more than about 25, not more than about 20, or not more than about 18 weight percent, or in the range of from about 5 to about 30, about 8 to about 25, or about 10 to about 20 weight percent. As used herein, the term “total solids content” refers to the concentration, by weight, of solids in a given stream, based on the total weight of the stream. The dry weight of a slurry is measured by weighing the residue of a sample after complete evaporation of the liquid phase. All values provided herein for the total solids content of various streams are given on a dry weight basis, unless otherwise noted The average particle size of the poly(vinyl acetal) resin particles in the reaction slurry can be at least about 50, at least about 60, at least about 75, at least about 80 microns, at least about 100, at least about 150, or at least about 200 microns and/or not more than about 1,000, not more than about 800, not more than about 700, not more than about 600, not more than about 500, not more than about 400 microns, or in the range of from about 50 to about 1,000, about 75 to about 500 or about 150 to about 400 microns, measured according to ASTM D1921, Method A.

The particle slurry withdrawn from reaction zone 20 can be at or near the reaction temperature when passed to separation zone 30. For example, the average temperature of the reaction slurry in conduit 116 can be at least about 5, at least about 15, at least about 25, at least about 40, at least about 45, at least about 55, at least about 55, at least about 60, at least about 65, at least about 70, at least about 75, at least about 80 and/or not more than about 105, not more than about 100, not more than about 95, not more than about 90, not more than about 85, or not more than about 75° C., or it can be in the range of from about 5 to about 105° C., from about 25 to about 100, from about 40 to about 95, or about 50 to about 90° C.

In certain embodiments, facility 10 may include at least one precipitation device (not shown) located between reaction zone 20 and wash zone 30. The precipitation device may be any device or vessel suitable for combining a solution of poly(vinyl acetal) polymer in a suitable solvent such as but not limited to methanol, ethanol, isopropanol etc. withdrawn from reaction zone 20 with water prior to introducing the resultant slurry into wash vessel 30. According to some embodiments, such a device may be used when, for example, the slurry exiting reaction zone 20 may comprises at least one organic solvent in place of, or in addition to, water.

According to some embodiments of the present invention, the particle slurry transported from reaction zone 20 to wash zone 30 via conduit 116 can optionally be combined with at least one dilution liquid, as shown by conduit 118 in FIG. 1, to provide a diluted reaction slurry in conduit 120. Any suitable amount of dilution liquid can be used and, in some embodiments, may be an amount sufficient to increase the mass flow rate of the reaction slurry in conduit 116 by at least about 5, at least about 10, at least about 20, or at least about 30 percent. When a dilution liquid is added to the reaction slurry in conduit 116, the ratio of the mass flow rate of the diluted reaction slurry in conduit 120 to the mass flow rate of the reaction slurry in conduit 116 can be at least about 1.1:1, at least about 1.2:1, at least about 1.5:1 and/or not more than about 5:1, not more than about 3:1, or not more than about 2:1, or it can be in the range of from about 1.1:1 to about 5:1, about 1.2:1 to about 3:1, or about 1.5:1 to about 2:1.

The dilution liquid can be any liquid suitable for addition to the reaction slurry as described above. In some embodiments, the dilution liquid in conduit 118 can comprise water in an amount of at least about 25, at least about 50, at least about 75, or at least about 90 weight percent. In some embodiments, the dilution liquid in conduit 118 can consist of water. The stream of dilution liquid may originate from one or more sources within or outside of facility 10, shown in FIG. 1, and may or may not originate from the same source as the yet-to-be-discussed wash liquid introduced into wash zone 30 via conduit 122. Various embodiments of additional sources from which the dilution liquid may originate will be described in further detail shortly.

Upon combination with the dilution liquid in conduit 118, the resulting diluted reaction slurry in conduit 120 can have a total solids content of at least about 0.5, at least about 1, at least about 2, at least about 2.5 and/or not more than about 10, not more than about 8, not more than about 5, or not more than about 3 weight percent, or it can be in the range of from about 0.5 to about 10, about 1 to about 8, or about 2 to about 5 weight percent. In some embodiments, the difference between the solids content of the reaction slurry in conduit 116 and the diluted reaction slurry in conduit 120 can be at least about 0.5, at least about 1, at least about 2, at least about 5, at least about 10 weight percent. As used herein, the phrase “difference between” refers to the mathematical difference between two given weight percentages, calculated by subtracting one number from the other. For example, the difference between a reaction slurry having a total solids content of 15 weight percent and a diluted reaction slurry having a total solids content of 10 weight percent is 5 weight percent (15 weight percent−10 weight percent=5 weight percent). As used herein, the term “different” can mean higher or lower. In some embodiments, the solids concentration of the dilute reaction slurry in conduit 120 is lower than the solids concentration of the reaction slurry in conduit 116. For example, the total solids concentration of the dilute reaction slurry in conduit 120 can be not more than about 90, not more than about 75, or not more than about 50 percent of the total solids content of the reaction slurry in conduit 116.

The temperature of the dilution liquid stream in conduit 118 can be similar to or different than the temperature of the reaction slurry in conduit 116. In some embodiments, the dilution liquid stream in conduit 118 can be cooler than the reaction slurry in conduit 116, such that, upon combination, the temperature of the reaction slurry is reduced. In other embodiments, the temperature of the dilution liquid in conduit 118 can be the same as or higher than the temperature of the reaction slurry in conduit 116. The temperature of the dilution liquid in conduit 118 may be about 5, at least about 8, at least about 10, at least about 12, or at least about 15° C. different than the temperature of the reaction slurry in conduit 116. In some embodiments, the temperature of the dilution liquid stream in conduit 118 can be at least about 20, at least about 25, at least about 30, at least about 35, at least about 40 and/or not more than about 70, not more than about 60, not more than about 50, not more than about 45, not more than about 40, or not more than about 30° C.

When the temperature of the reaction slurry in conduit 116 falls within the ranges described above, the resulting diluted slurry in conduit 120 can have a temperature of at least about 25, at least about 30, at least about 35, at least about 40 and/or not more than about 70, not more than about 65, not more than about 60, not more than about 55, not more than about 50° C., or it can be in the range of from about 25 to about 70, about 30 to about 65, or about 40 to about 60° C. This can, in some embodiments, represent a reduction in temperature of the reaction slurry in conduit 116 of at least about 5, at least about 10, at least about 15, at least about 20 and/or not more than about 45, not more than about 40, not more than about 30, or not more than about 25° C., or by an amount in the range of from about 5 to about 45, about 10 to about 40, or about 15 to about 30° C.

In other embodiments of the present invention, the reaction slurry in conduit 116 may be directly introduced into wash zone 30 without the addition of a dilution liquid in conduit 118. According to such embodiments, the temperature of the reaction slurry introduced into wash zone 30 can be the same, or nearly the same, as the temperature of reaction slurry in conduit 116 described above, and the total solids content may also be within one or more of the ranges described previously. In some embodiments, facility 10 may be configured such that the dilution liquid in conduit 118 may be added on a non-continuous or as-needed basis, such that the dilution liquid in conduit 118 may be selectively added to the reaction slurry in conduit 116.

In addition to poly(vinyl acetal) resin particles and liquid, the reaction slurry and/or diluted reaction slurry may also include one or more other components that are typically undesirable when present in the final resin particles, especially in high concentrations. Examples of these components can include, but are not limited to, residual catalyst, metal salts, unreacted materials, including aldehydes, reaction byproducts, and combinations thereof. In some embodiments, one or more of these additional components may be present in the reaction slurry and/or diluted reaction slurry in an amount of at least about 50, at least about 100, at least about 250, at least about 500, at least about 1000 and/or not more than about 15,000, not more than about 12,500, not more than about 10,000, not more than about 7500, not more than about 5000, not more than about 2500, or not more than about 1500 ppmw, or these could be present in an amount in the range of from 50 to about 15,000, about 100 to about 10,000, or about 500 to about 7500 parts per million by weight (ppmw). In many cases, failure to remove such components from the resin particles may result in increased operating inefficiencies during subsequent processing of the particles and/or defects in the final products, such as sheets or interlayers, formed with the dried resin particles.

To remove these unwanted components from the poly(vinyl acetal) resin particles, the reaction slurry or diluted reaction slurry in conduit 120 can be introduced into a wash zone 30, wherein at least a portion of the poly(vinyl acetal) resin particles may be contacted with at least one wash liquid. In some embodiments, the total amount of undesired components, including one or more of those listed above, present in the washed particle slurry removed from wash zone 30 via conduit 124 can be not more than about 1000, not more than about 750, not more than about 500, not more than about 250, not more than about 100, not more than about 75, not more than about 50, or not more than about 20 ppmw. This can represent a reduction in unwanted components of at least about 50, at least about 60, at least about 70, at least about 75, at least about 85, at least about 90, at least about 95 percent, as compared to the slurry introduced into wash zone 30 via conduit 120.

The step of contacting the poly(vinyl acetal) resin particles with a wash liquid performed in wash zone 30 can be carried out in a batch, semi-batch, or continuous manner. The contacting may be performed in a single wash vessel, or in two or more wash vessels arranged in parallel or in series. In some embodiments, at least one of the reacting step performed in reaction zone 20 and the contacting step performed in wash zone 30 may be performed continuously, while the other step may be carried out in a batch or semi-batch manner. Alternatively, both the reacting and contacting steps may be carried out in a batch or semi-batch manner, or both may be done continuously. The average residence time of the poly(vinyl acetal) resin particles within wash zone 30 can be, for example, at least about 15, at least about 30, at least about 60, at least about 90 minutes and/or not more than about 360, not more than about 300, or not more than about 240 minutes, or it can be in the range of from about 30 to about 360 minutes, about 60 to about 300 minutes, or about 90 to about 240 minutes.

As shown in FIG. 1, the wash liquid introduced into wash zone 30 via conduit 122 may originate from one or more sources within or outside of facility 10. For example, in some embodiments, the wash liquid can comprise at least one liquid transported to facility 10 via conduit 121, while, in some embodiments, all or a portion of the wash liquid in conduit 122 can originate from one or more locations within facility 10, typically from locations at or downstream of wash zone 30. In the embodiment shown in FIG. 1, portions of the wash liquid stream in conduit 122 may originate from yet-to-be-discussed filtered liquid streams in conduits 138b and/or 146 removed from wash zone 30 and/or separation zone 40.

The wash liquid in conduit 122 can comprise any liquid suitable for contacting the poly(vinyl acetal) resin particles. In some embodiments, the wash liquid in conduit 122 can comprise or be water, and may include, for example, at least about 50, at least about 60, at least about 70, at least about 80, at least about 90, at least about 95 weight percent water, based on the total weight of the liquid in conduit 122. In some embodiments, the wash liquid may include other components, such as a neutralizing agent, in order to further reduce or remove one or more contaminants from the slurry. For example, when the slurry introduced into wash zone 30 has an acidic pH of not more than about 6, not more than about 5, not more than about 4, not more than about 3, or not more than about 2, the wash liquid in conduit 122 may comprise a neutralizing agent having a pH of at least about 7.5, at least about 8, at least about 8.5, or at least about 9. Alternatively, the wash liquid may have a pH of less than about 6, less than about 5, or less than about 4, when the slurry has a basic pH greater than 8. In some embodiments, the neutralizing agent may be added intermittently, such that the wash liquid stream in conduit 122 has an acidic or basic pH for only a portion of the contacting step performed in wash zone 30.

The wash liquid in conduit 122 may be substantially free of solids. For example, in some embodiments, the total solids content of the wash liquid in conduit 122 can be not more than about 0.05, not more than about 0.01, or not more than about 0.005 weight percent. If present, the solids in wash liquid 122 may have a smaller average particle size than the solids present in the slurry introduced into wash zone 30 and can, for example, have an average particle size of not more than about 50, not more than about 40, not more than about 30, not more than about 20, or not more than about 10 microns.

The wash liquid can be at any suitable temperature and, in some embodiments, the temperature of the wash liquid in conduit 122 can be at least about 2, at least about 5, at least about 10, at least about 15, at least about 20, at least about 25, at least about 30, at least about 35 and/or not more than about 90, not more than about 85, not more than about 80, not more than about 75, not more than about 65, not more than about 50, or not more than about 40° C., or in the range of from about 2 to about 90, about 15 to about 80, or about 20 to about 75° C. Depending on the origin of the wash liquid, the stream in conduit 122 (and/or one or more streams contributing thereto) may optionally be heated or cooled in one or more heat exchangers (not shown in FIG. 1) prior to being introduced into wash zone 30. Such heating or cooling may be performed via indirect heat exchange with one or more heat exchange fluids, such as, for example, cooling water, steam, or another process stream of higher or lower temperature, and/or it may be performed via direct heat exchange with steam or cooled or ice water.

In addition to removing contaminants, the wash liquid may also reduce the temperature of the slurry in wash zone 30. For example, in some embodiments, when contacted with the slurry, which can have a temperature within the ranges described previously, the wash liquid may reduce the temperature of the wash vessel contents by at least about 5, at least about 10, at least about 15, at least about 20, at least about 30, or at least about 40° C. Such a reduction may take place over a period of time of, for example, at least about 15 minutes, at least about 30 minutes, at least about 1 hour, at least about 2 hours, or at least about 3 hours. At the end of the contacting step, the washed particle slurry within wash zone 30 may have a temperature of not more than about 50, not more than about 45, not more than about 40, not more than about 35, not more than about 30, or not more than about 25° C.

In some embodiments, the wash liquid may be continuously introduced into wash zone 30 and one or more streams of spent wash liquid may be continuously removed from separation zone 30 as shown in FIG. 1. According to some embodiments of the present invention, facility 10 may further comprise one or more filtration devices configured to separate at least a portion of the poly(vinyl acetal) resin particles from at least a portion of the spent wash liquid within and/or removed from wash zone 30. In some embodiments, one or more filtration devices, generally represented by filter element 60 in FIG. 1, may be located within one or more wash vessels (not shown) disposed within wash zone 30. In the same or other embodiments, one or more filtration devices, generally represented by filter 62 in FIG. 1, may also be located external to the wash vessels and can be configured to filter at least a portion of the spent wash liquid and/or washed poly(vinyl acetal) resin slurry withdrawn from wash zone 30 via conduit 126. Specific embodiments of various filtration devices suitable for use in facility 10 will be discussed in detail shortly.

When facility 10 includes at least one filter element 60 disposed within the interior of a wash vessel within wash zone 30, at least a portion of the spent wash liquid can be passed through the filter elements before being removed from the vessel via conduit 125. As a portion of the liquid within wash zone 30 is passed through the filter, at least a portion of the solid poly(vinyl acetal) resin particles can be retained within the interior of the vessel, thereby providing a solids-enriched retentate phase within the vessel and a solids-depleted permeate stream. The solids-depleted permeate stream, at least a portion of which may be withdrawn from the wash vessel as a stream of spent wash fluid in conduit 125, may have total solids content lower than the solids-enriched retentate phase retained within the wash vessel and may also have a total solids content lower than the slurry introduced into the wash vessel in conduit 120.

In some embodiments, the spent wash liquid stream in conduit 125 may have a total solids content of at least about 0.001, at least about 0.0025, at least about 0.005, at least about 0.010, at least about 0.050, at least about 0.10 and/or not more than about 10, not more than about 8, not more than about 5, not more than about 4, not more than about 3, not more than about 2, not more than about 1, or not more than about 0.50 weight percent. The total solids content of the spent wash liquid stream in conduit 125 can be in the range of from about 0.001 to about 10, about 0.005 to about 8, or about 0.010 to about 5 weight percent. In some embodiments, the average particle size of the solid particles present in the solids-depleted permeate stream in conduit 125 can be smaller than the average particle size of the poly(vinyl acetal) resin particles in the slurry introduced into wash zone 30. For example, the average particle size of the poly(vinyl acetal) resin particles present in the solids-depleted stream in conduit 125 can be not more than about 50, not more than about 30, not more than about 20, not more than about 15, not more than about 10, or not more than about 5 microns, which may be at least about 30, at least about 40, at least about 50, at least about 60, or at least about 70 percent less than the average particle size of the poly(vinyl acetal) resin particles present in the slurry introduced into wash zone 30 in conduit 120.

In certain embodiments, a solids-containing stream withdrawn from wash zone 30 in conduit 126 may be introduced into at least one filter 62 located external to the wash vessel within wash zone 30. Filter 62 may be any suitable device for filtering at least a portion of the solids-containing stream and may include one or more filters, arranged in series or in parallel. Each filter may further include one or more filtration elements. Additional details regarding specific embodiments of suitable filters and filter elements will be discussed shortly. In some embodiments, the temperature of the solids-containing stream in conduit 126 passing through filter 62 can be at least about 25, at least about 30 at least about 40, at least about 45, at least about 50, at least about 55, at least about 60, or at least about 65° C. The total solids content of the stream in conduit 126 introduced into filter 62 can be at least about 5, at least about 8, at least about 10, at least about 12 and/or not more than about 30, not more than about 25, not more than about 20, or not more than about 18 weight percent, or in the range of from about 5 to about 30, about 8 to about 25, or about 10 to about 20 weight percent.

As shown in FIG. 1, filter 62 may be configured to separate the solids-containing stream in conduit 126 into a solids-enriched retentate stream in conduit 132 and a solids-depleted permeate stream in conduit 134. In some embodiments, the solids-enriched retentate stream in conduit 132 can include at least about 60, at least about 65, at least about 70, at least about 75, at least about 80, at least about 85, or at least about 90 percent of the total amount of solids present in the solids-containing stream introduced into filter 62 via in conduit 126. The solids-depleted permeate stream in conduit 134 can comprise not more than about 40, not more than about 35, not more than about 30, not more than about 25, not more than about 20, not more than about 15, not more than about 10, not more than about 5, or not more than about 1 weight percent of the total amount of solids introduced into filter 62 in the solids-containing stream in conduit 126.

As it passes through filter 62, the total solids content of the portion of the stream retained by the filter may be increased. For example, the total solids content of the retained phase may be increased by an amount of at least about 0.5, at least about 1, at least about 1.5, or at least about 2 weight percent, such that the total solids content of the solids-enriched retentate stream in conduit 132 can be at least about 0.5, at least about 1, at least about 2, at least about 4 weight percent, at least about 6, at least about 8, at least about 10, at least about 12 weight percent and/or not more than about 30, not more than about 25, not more than about 20, not more than about 18, not more than about 15, not more than about 12 weight percent. According to some embodiments, the difference between the total solids content of the solids-containing stream introduced into filter 62 and the solids-enriched retentate stream in conduit 132 can be at least about 0.5, at least about 1, at least about 2 and/or not more than about 10, not more than about 8, not more than about 5, not more than about 3, or not more than about 2 weight percent.

As shown in FIG. 1, at least a portion of the solids-enriched retentate stream in conduit 132 can be recycled back to the process at a location at or downstream of wash zone 30. In some embodiments, at least a portion of the solids-enriched retentate stream in conduit 132 can be returned to wash zone 30 via conduit 136a, wherein it can be introduced directly into wash zone 30 via conduit 137b, or it can be routed via conduit 137a for combination with the slurry in conduit 120 prior to being introduced into wash zone 30. In some embodiments, at least a portion of the solids-enriched retentate stream in conduit 136b can be optionally combined with a washed particle slurry withdrawn from wash zone 30 in conduit 124a and the combined stream may be introduced into separation zone 40, as shown by conduit 139. Once returned to the process, the recovered poly(vinyl acetal) resin particles may be continued through the remaining process stages as described herein.

The solids-depleted permeate stream in conduit 134 can have a total solids content less than the solids-containing stream introduced into filter 62 in conduit 126 and less than the solids-enriched retentate stream in conduit 132. In some embodiments, the total solids content of the solids-depleted permeate stream in conduit 134 may be not more than about 1, not more than about 0.5, not more than about 0.1, not more than about 0.05, not more than about 0.01, or not more than about 0.005 weight percent. As shown in FIG. 1, at least a portion of the solids-depleted permeate stream withdrawn from filter 62 in conduit 134 may be optionally combined with a spent wash fluid stream in conduit 125, if present, and the combined stream can be returned to the facility 10 and reintroduced into the process at or upstream of wash zone 30. In particular, in some embodiments, at least a portion of the permeate stream in conduit 125 and/or conduit 134 may be reintroduced directly into wash zone 30 for use as a wash liquid, as shown by conduit 138a, or it may be combined with the wash liquid stream in conduit 122, as shown by conduit 138b.

Upon introduction into wash zone 30, at least a portion of the recycled portion of the solids-depleted permeate stream may be used for contacting the poly(vinyl acetal) resin particle as described in detail previously. When all or a portion of the solids-depleted streams in conduit 125 and/or conduit 134 are recycled back to wash zone 30, the flow rate of these recycled streams in conduits 138a and/or 138b can be substantially less than the fresh wash liquid in 122. For example, in some embodiments, the flow rate of the wash liquid in conduit 122 can be at least about 25, at least about 40, at least about 50, at least about 75 percent higher than the total flow rate of the spent wash liquid returned to wash zone 30 via conduits 138a and 138b. Alternatively, all or a portion of the solids-depleted permeate stream in conduit 125 and/or the solids-depleted permeate stream in conduit 134 may be routed out of facility 10 for further storage and/or disposal, as shown by conduit 190.

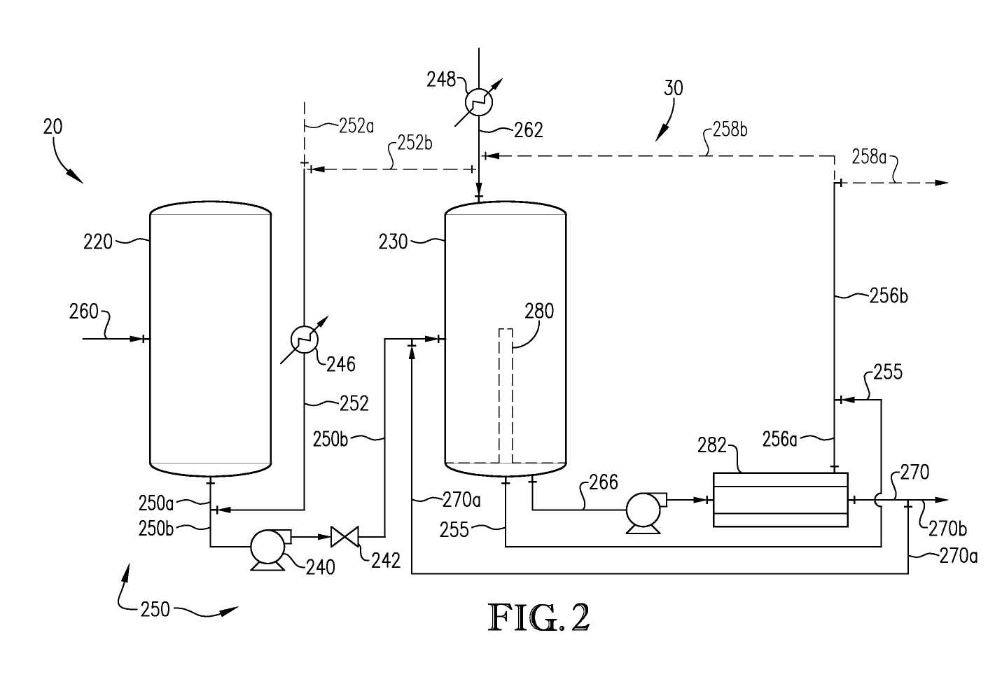

Turning now to FIG. 2, a reaction zone 20 and a wash zone 30 configured according to one or more embodiments of the present invention are shown as generally comprising a reaction vessel 220, a wash vessel 230, and a slurry transfer conduit 250 for transporting the reaction slurry from reaction vessel 220 to wash vessel 230. Additionally, the portion of the resin production facility shown in FIG. 2 further comprises a dilution liquid conduit 252 for diluting at least a portion of the slurry in transfer conduit 250, and two filtration devices 280 and 282 for respectively filtering solids from at least a portion of the washed particle slurry within the interior of and withdrawn from wash vessel 230.

In operation, one or more components introduced into reaction vessel 220 via conduit 260 may be reacted to form a solid particle slurry, as described above. The slurry may then be removed from reaction vessel 220 and passed to a wash vessel 230 via transfer conduit 250. As shown in FIG. 2, transfer conduit 250 may comprise a first segment 250a and a second segment 250b, wherein the first segment 250a is positioned between the slurry outlet of reaction vessel 220 and the point at which the dilution liquid in conduit 252 is introduced into transfer conduit 250 and the second segment 250b is positioned between the point at which the dilution liquid in conduit 252 is introduced and the slurry inlet of the wash vessel 230. In some embodiments, first segment 250a may be positioned closer to the slurry outlet of reaction vessel 220 than to the slurry inlet of wash vessel 230, such that the linear distance of first segment 250a is less than the linear distance of second segment 250b. As used herein, the term “linear distance” is the total distance traveled by the slurry in a given conduit and is calculated by adding the total length of straight pipe plus the equivalent length of any fittings, calculated according to standard conversion charts, for that conduit. In some embodiments, the linear distance of first segment 250a of transfer conduit 250 can be at least about 10, at least about 25, at least about 35, at least about 50, at least about 65, or at least about 75 percent less than the linear distance of second segment 250b.

In some embodiments, the diameter of second segment 250b of transfer conduit 250 can be larger than the diameter of first segment 250a. As a result, the average cross-sectional flow area of second segment 250b of transfer conduit 250 may be at least about 10, at least about 20, at least about 25, at least about 30 percent larger than the average cross-sectional flow area of first segment 250a of transfer conduit 250. The average velocity of the slurry passing through first and second segments 250a,b of transfer conduit 250 can be similar or may be different from each other, although the average velocity in both segments 250a,b may be at least about 8, at least about 10, at least about 12 feet per second (ft/s). In some embodiments, transfer conduit 250 may include one or more pressurization devices, such as, for example, a pump 240, for increasing the pressure of the slurry, thereby maintaining sufficient pressure drop and adequate fluid velocity within transfer conduit 250.

As discussed previously, the dilution liquid in conduit 252 may originate from any suitable source, including a source within or outside of the facility. In some embodiments shown by dashed line 252a, at least a portion of the dilution liquid in conduit 252 may originate from a different source than the wash liquid in conduit 262 introduced into wash vessel 230, and/or at least a portion of the dilution liquid in conduit 252 may originate from the same source as the wash liquid, as shown by dashed line 252b. Prior to being introduced into transfer conduit 250, the dilution liquid stream in conduit 252 may be passed through at least one heat exchange device, shown in FIG. 2 as heat exchanger 246, wherein the stream may be heated or cooled to a desired temperature via indirect heat exchange with at least one stream of heat exchange media. Depending on the source of the dilution liquid and the availability of various streams, the heat exchange media used in heat exchanger 246 may be a dedicated heat exchange media, such as thermal heat transfer media or cooling water, or it may comprise all or a portion of one or more process streams within facility 10.

Once combined with the dilution liquid, when present, the slurry in transfer conduit 250 may pass through at least one flow restriction device, shown in FIG. 2 as control valve 242, before being introduced into wash vessel 230. The flow restriction device may be any device suitable for controlling or at least partially controlling the flow rate of the slurry between reaction vessel 220 and wash vessel 230, and it may have an average cross-sectional flow area less than the average cross-sectional flow area of the transfer conduit adjacent to the flow restriction. For example, in some embodiments, the average cross-sectional flow area of the flow restriction may be at least about 10, at least about 20, at least about 30, at least about 40, at least about 50, at least about 60 percent less than the average cross-sectional flow area of the transfer conduit adjacent to and on either side of the restriction. Examples of suitable flow restrictions may include, but are not limited to, reduced port block valves, control valves, including automated control valves and manual control valves, orifice plates, and combinations thereof. Although shown in FIG. 2 as including a single flow restriction 242, two or more flow restrictions, of the same or different types, may also be used depending on the specific configuration of the system.

When the system shown in FIG. 2 does not include a flow restriction, shown as control valve 242 in FIG. 2, the rate of discharge of the reaction slurry between reaction vessel 220 and wash vessel 230 may be quite rapid and, as a result, most poly(vinyl acetal) resin particles within reaction vessel 220 may have approximately the same residence time. As a result, the residence time distribution of the poly(vinyl acetal) resin particles may be very narrow and can approach a 6 function in the theoretical limit. In some embodiments, use of a flow restriction, shown in FIG. 2 as flow control device 242, may help control the flow rate of the poly(vinyl acetal) resin particle slurry from reaction vessel 220 to wash vessel 230, thereby allowing the flow rate to be varied over a wider range. As a result, the residence time distribution of the poly(vinyl acetal) resin particles within reaction vessel 220 may be wider than if the flow restriction were not present. The breadth of the residence time distribution may depend, in part, on the flow rate of the reaction slurry discharged from reaction vessel 220. Addition of a dilution liquid via conduit 252 and/or washing of the poly(vinyl acetal) resin particles with a wash liquid via conduit 262 may help decelerate the reaction considerably within transfer line 250 and/or wash vessel 230 by reducing the effective concentration of the residual reactant and the catalytic species.

As shown in FIG. 2, upon exiting flow restriction device 242, the slurry may be directed into a slurry inlet of wash vessel 230. Upon introduction into wash vessel 230, at least a portion of the solid particles may be contacted with a wash liquid added to vessel 230 via conduit 262. In some embodiments, the wash liquid may be heated or cooled via indirect heat exchange with a heat transfer medium or via direct heat exchange with steam, cooled water, ice, or the like, as generally shown by exchanger 248 in FIG. 2, before being introduced into wash vessel 230.

Additionally, as shown in FIG. 2, the wash liquid in conduit 262 may be introduced into wash vessel 230 in a counter-current manner, such that the solid and liquid phases are flowing in generally opposite directions. Such counter-current operation may also be performed when wash zone 30 includes two or more wash vessels operated in series (not shown). In some embodiments, the contents of wash vessel 230 may be agitated during the contacting step with one or more agitators disposed within the interior of wash vessel 230. The agitator or agitators, when present, may be centrally located, at or near the vertical center-line of the wash vessel, or one or more of the agitators may be off-center. Additionally, one or more of the wash vessels may include baffles, or no baffles may be present.

After contacting at least a portion of the solid particles with a wash liquid, at least a portion of the spent wash liquid may be withdrawn from wash vessel 230 via conduit 255. In some embodiments, wash vessel 230 may include at least one internal filtration device, shown in FIG. 2 as filter element 280, disposed within the vessel for removing at least a portion of the solid particles from at least a portion of the spent wash liquid before the liquid is removed from the wash vessel 230 via conduit 255. Several embodiments of various internal filtration devices suitable for use in wash vessel 230 will be discussed in detail shortly.

In some embodiments, the system shown in FIG. 2 may include at least one external filtration device. As shown in FIG. 2, at least a portion of the contents of wash vessel 230 may be withdrawn via conduit 266 and may be passed through at least one external filtration device 282 to provide another solids-depleted permeate stream in conduit 256a and a solids-enriched stream in conduit 270. As shown in FIG. 2, the solids-depleted permeate stream withdrawn from filter 282 in conduit 256a may optionally be combined with at least a portion of a spent wash liquid stream withdrawn from wash vessel 230 in conduit 255, if present, and the combined stream in conduit 256b may be routed for disposal via conduit 258a or it may be combined with the wash liquid in conduit 262 via conduit 258b and returned to wash vessel 230. In some embodiments, all or a portion of the recycled liquid in conduit 258b may be routed to and held in one or more intermediate hold tanks (not shown) for use in an upcoming wash cycle. At least a portion of the solids-enriched stream in conduit 270 may be routed to a downstream separation zone (not shown) via conduit 270b, and/or, as shown in FIG. 2, at least a portion of the stream may be routed via conduit 270a to be combined with the washed particle slurry withdrawn from reaction vessel 220 in conduit 250b and the combined stream may be reintroduced into wash vessel 230. Alternatively, the stream in conduit 270a may be directly returned to wash vessel 230 via one or more separate nozzles (not shown). Although depicted in FIG. 2 as including both internal and external filtration devices, it should be understood that systems configured according to various embodiments of the present invention may include at least one internal filtration device, at least one external filtration device, or at least one internal device and at least one external filtration device.

When present, the internal and/or external filtration devices may be any suitable filtration devices configured to remove at least a portion of the solid particles from a liquid stream. Internal and/or external filtration devices 280, 282 may include any suitable number of filtration stages or filter elements, which, when two or more are present, may be operated in parallel or in series. Any number of filter stages or elements may be used by or within the internal and/or external filtration devices and, in some embodiments, may number at least about 1, at least about 2, at least about 4, at least about 8, at least about 10, at least about 12 and/or not more than about 50, not more than about 40, not more than about 30, or not more than about 25, or in the range of from about 1 to about 50, about 2 to about 30, or about 4 to about 25.

The filter elements utilized as or within the internal filtration device and/or external filtration device, when present, can be any suitable size. For example, in some embodiments, each filter element can have a total length, or longest dimension, of at least about 0.5, at least about 1, at least about 4, at least about 6 feet and/or not more than about 40, not more than about 30, not more than about 20, or not more than about 15 feet, or in the range of from about 0.5 to about 40, about 1 to about 30, or about 6 to about 15 feet. Each filter element may be a single continuous element, or may comprise two or more elements coupled to one another such as, for example, via welding or other suitable technique. The inner diameter of one or more filter elements can be at least about 0.10, at least about 0.25, at least about 0.50, at least about 1, at least about 2, at least about 4, at least about 6, at least about 8, at least about 12 and/or not more than about 24, not more than about 18, not more than about 12, not more than about 8, not more than about 6, not more than about 2, not more than about 1.5 inches, or not more than about 1 inch, or in the range of from about 0.10 to about 24, about 2 to about 18, or about 4 to about 12 inches. According to some embodiments, at least one filter element may have a nominal filter rating of at least about 0.1, at least about 0.50, at least about 1, at least about 2 and/or not more than about 50, not more than about 30, not more than about 25, or not more than about 20 microns, or a rating in the range of from about 0.1 to about 50, about 0.5 to about 30, about 1 to about 25, or about 2 to about 20 microns.

The filter elements may be formed from any suitable material of construction including, but not limited to, stainless steel alloys, such as SS304L and SS316L, titanium, corrosion-resistant nickel and nickel alloys. Ideally, each filter element is formed from a material non-reactive with the feed passing therethrough. In some embodiments, one or more of the filter elements may be made of a non-metallic material, such as ceramics, glass, and the like. Whether used within internal or external filtration devices 280 or 282, the filter elements can be mounted in any suitable manner and may, in some embodiments, comprise multiple layer filter elements secured with a mounting frame, a back plate, a mesh screen, and optional retainer bracket (not shown). In some embodiments, the mesh screen may be formed from one or more of the metallic materials listed above, or it may be formed from a filter cloth comprising, for example, monofilament polypropylene fabric.

The filter elements utilized by filters 280 and/or 282, when present, may be configured to minimize agglomeration and plugging of the filter surface, such that fouling of the filtration device is minimized during operation of the system. For example, in some embodiments, one or more of the filter elements utilized by filtration devices 280 and/or 282 may be backwashed filter elements. When one or more elements are backwashed, any suitable back wash fluid may be used. Examples of suitable fluids can include, but are not limited to, pressurized air, nitrogen, and other inert gases. The backwash pressure and intervals are not particularly limited and can be selected to minimize agglomeration of the solid resin particles at the filter surface. In some embodiments, one or more of the filter elements are self-cleaning and are not backwashed elements.

Whether back-washed or self-cleaning, filter elements configured according to embodiments of the present invention can retain a substantially constant permeate flux during the operation of the filter. For example, in some embodiments, after a continuous operating period of at least about 30 minutes, at least about 1 hour, or at least about 2 hours, the average permeate flux through a specified filter element can within about 25, within about 20, within about 15, or within about 10 percent of the average permeate flux at the beginning of the continuous operating period. According to some embodiments, the average permeate flux across the surface one or more filter elements employed in devices 280 and/or 282 can be at least about 0.10, at least about 0.20, at least about 0.25, at least about 0.30, or at least about 0.40 gallons per minute per square foot of filter surface (gpm/ft²).

In some embodiments, the internal and/or external filtration devices may include one or more cross-flow filter elements. Unlike dead-end filter elements, which permit the slurry being filtered to pass generally perpendicularly through the filter surface, cross-flow filter elements can be configured to permit the feed slurry to pass over a significant portion of the filter surface as a portion of the liquid phase passes through the filter element with minimal or no wet cake accumulating on the filer media surface. As a result, the cross-flow filter elements can be configured to concentrate solids in the retentate phase, thereby providing a solids-depleted permeate phase and a solids-enriched retentate phase. In some embodiments, the solids-enriched retentate stream has a concentration of solids that is not more than about 10, not more than about 8, not more than about 5, not more than about 3, or not more than about 2 weight percent different than the concentration of solids in the feed stream introduced into the filter. Further, unlike most dead-end filtration devices, cross-flow filter elements may be operated in a continuous manner. In one embodiment, cross flow filter elements inside the wash vessel elements may be positioned along, or integrated into, one or more of the internal side walls or bottom wall of wash vessel 230.

As shown in FIG. 2, when wash vessel 230 includes one or more internal filter elements, the elements may be positioned along, or integrated into, one or more of the internal side walls or bottom wall of wash vessel 230. In some embodiments, at least one of the internal filter elements can be positioned at or near one or more outlet nozzles (not shown) of wash vessel 230. Any suitable type of filter may be used as an internal filtration device and, in some embodiments, the internal filtration device disposed within wash vessel 230 may include at least one filter device selected from the group consisting of screen filters, candle filters, pressure leaf filters, and combinations thereof.

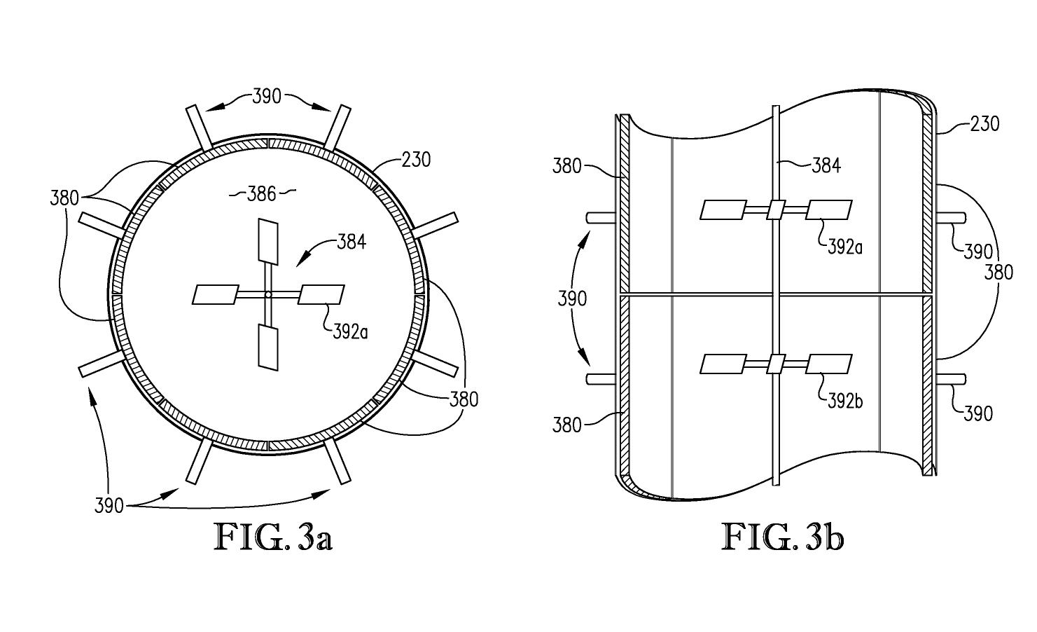

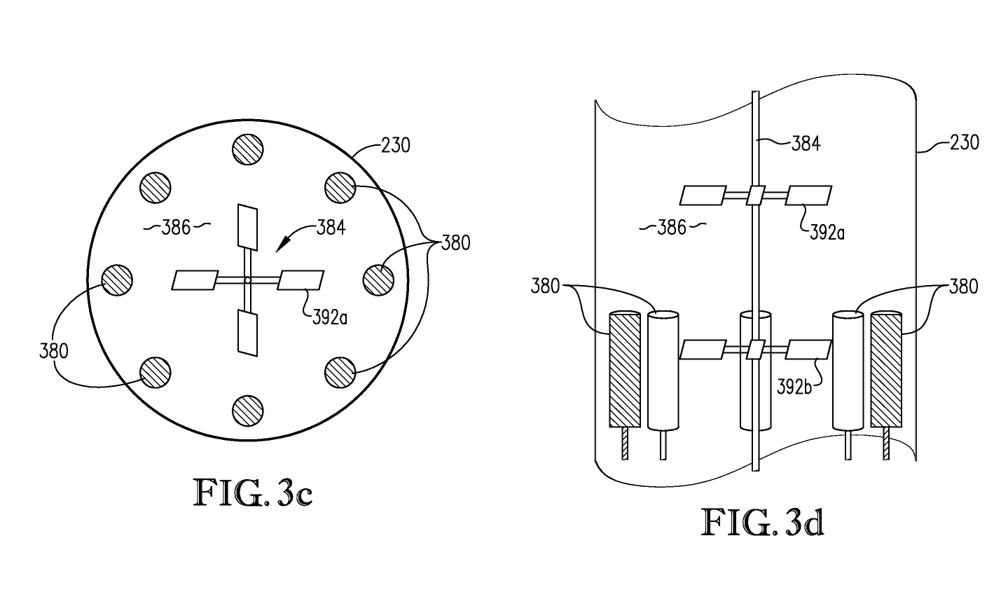

In some embodiments, generally depicted in FIGS. 3a and 3b, wash vessel 230 can include a plurality of screen filters 380 disposed along the inner wall of vessel 230. As shown in FIGS. 3a and 3b, screen filters 380 may be disposed between the interior volume 386 of wash vessel 230 and one or more outlet nozzles 390 disposed at various locations along the outer wall of vessel 230. In some embodiments, one or more of the outer nozzles 390 may be located in the bottom one-half, bottom one-third, or bottom one-fourth of the vertical dimension of one or more of the filter elements. In other embodiments, generally shown in FIGS. 3c and 3d, wash vessel 230 can include a plurality of candle filters 380 spaced from one another within the interior of vessel 230. Similarly, candle filters 380 shown in FIGS. 3c and 3d may also be positioned between the interior of wash vessel 230 and one or more fluid outlets (not shown).

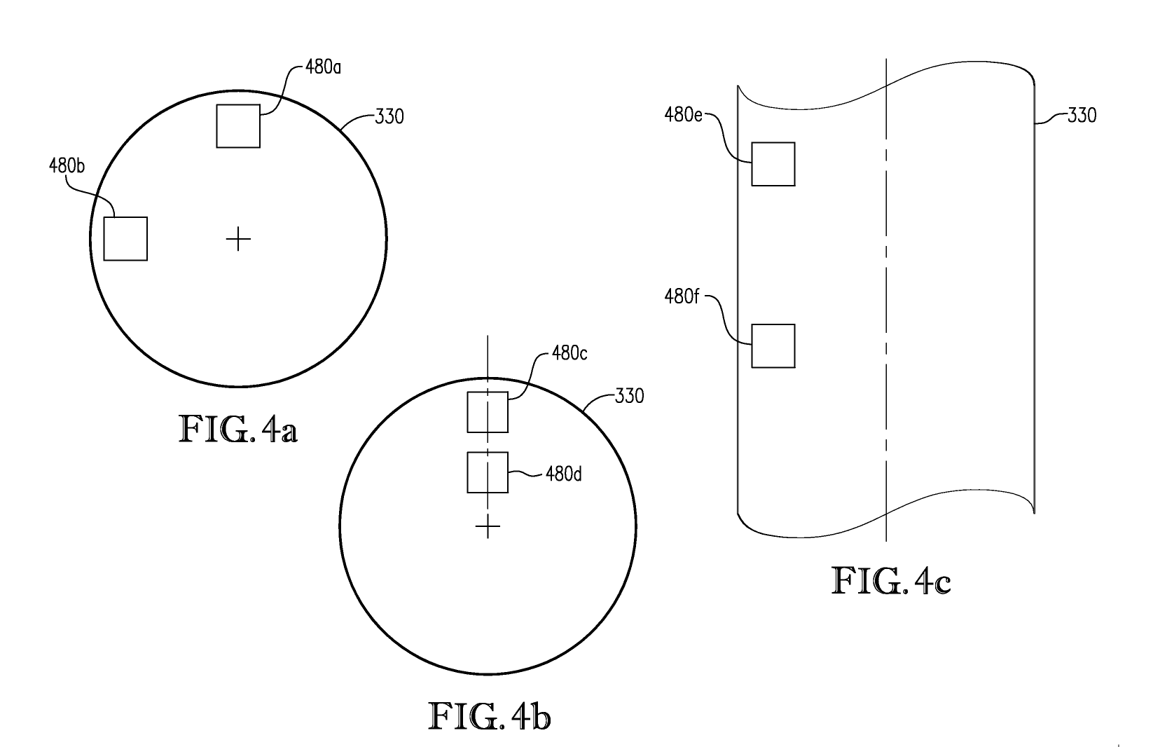

When wash vessel 230 includes two or more internal filter elements, the elements can be spaced apart from one another within the interior of the vessel 230. In the elements can be circumferentially spaced from one another, radially spaced from one another, and/or vertically spaced from one another. As used herein, the term “circumferentially spaced” refers to two elements that are spaced from each other along the inner perimeter of the vessel. An example of two circumferentially-spaced elements 480a and 480b located within the interior of a wash vessel 330 is schematically depicted in FIG. 4a. As used herein, the term “radially spaced” refers to two elements that are spaced from each other along a vessel radius (R) that extends from the vessel center line (CL) to the outer wall of the vessel. One example of two radially-spaced elements 480c and 480d within a wash vessel 330 is shown in FIG. 4b. As used herein, the term “vertically spaced” refers to two elements spaced from one another along the vertical centerline (CL) of the wash vessel. One example of two vertically-spaced elements 480e and 480f disposed within the interior of wash vessel 330 is schematically depicted in FIG. 4c. When more than two interior filter elements are utilized, each of the elements can be circumferentially, radially, and/or vertically spaced from one another within the interior of the vessel and may be operated in series or in parallel.

Additionally, as shown in FIGS. 3a-3d, wash vessel 230 can include at least one agitation device 384 for agitating the contents of wash vessel 230. The agitator may be any suitable type of mechanical agitation device can include one or more impellers 392a,b for imparting shear force and velocity to the surrounding fluid. At least a portion of the contacting step performed in wash vessel 230 can include agitating the slurry within the wash vessel and passing at least a portion of the agitated slurry across the surface of the filter element or elements. In some embodiments, the portion of the slurry passed or flowing across the face of the filtration element within vessel 230 may do so at an average cross-flow velocity of at least about 0.5, at least about 1, at least about 2, at least about 5, at least about 8, at least about 10 feet per second (ft/s) and/or not more than about 20, not more than about 15, or not more than about 12 ft/s. In some embodiments, the average cross-flow velocity can be in the range of from about 0.5 to about 30, about 1 to about 15, or about 2 to about 12 ft/s. In contrast, many dead-end filtration devices have an average cross-flow velocity near 0 ft/s. Examples of dead-end filtration devices can include, but are not limited to vacuum belt filters, rotary drum filters, rotary vacuum filters, belt filters, and combinations thereof.

In some embodiments, the pressure drop across the filter surface of filter element 280 may be substantially less than the pressure drop across conventional filtration devices. For example, the average cross-membrane pressure drop across the filter surface during the passing step can be not more than about 10, not more than about 8, not more than about 5, not more than about 3, or not more than about 2 pounds per square inch per square foot of filter surface (psi/ft²). Such a pressure drop may be achieved in combination with the average-cross flow velocity and permeate flux described herein.

Referring again to FIG. 2, the external filtration device, shown as filter 282, can be any device suitable for filtering a portion of the spent wash liquid withdrawn from wash vessel 230 as described previously. External filtration device 282 can include a single stage filtration device, or it may include a multiple stage filtration device having two or more filter stages arranged in series or in parallel. In some embodiments, two or more of the filter elements used in external filtration device may be the same, while, in other embodiments, one or more elements may be different. The filter elements may include one or more of the elements described herein. The velocity of the feed introduced into at least one of the filter elements of the external filtration device 282 can be at least about 2, at least about 5, at least about 7, or at least about 10 ft/s and/or not more than about 35, not more than about 30, not more than about 25, or not more than about 20 ft/s. In some embodiments, one or more filter elements employed by filter 282 may be cross-flow filter elements and/or one or more may be a dead-end filter element or device. In some embodiments, none of the filter elements in filter 282 may be dead-end filter elements or filtration devices.

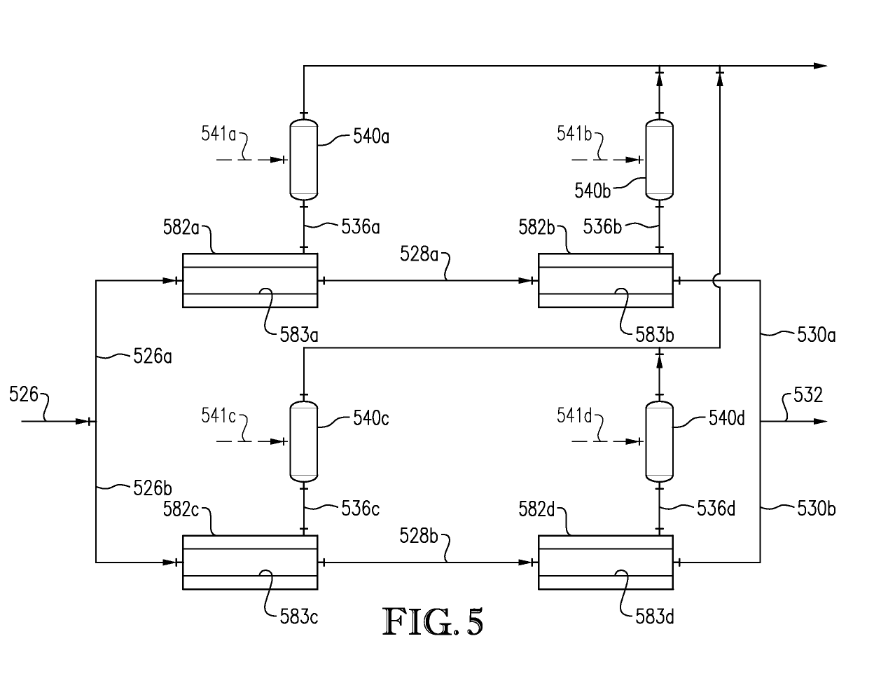

Turning now to FIG. 5, one example of a suitable external filtration device for use with the system shown in FIG. 2 is provided. As shown in FIG. 5, the filtration device includes a plurality of individual filters 582a-d, arranged in parallel and in series. In the embodiment shown in FIG. 5, a solids-containing liquid stream in conduit 526 is divided into two portions in conduit 526a and 526b. The solids-containing liquid stream in conduit 526 can be withdrawn from a wash vessel similar to wash vessel 230, as shown in FIG. 2, and can have a total solids content similar to the total solids content of the solids-containing stream in conduit 126 described above with respect to FIG. 1. As shown in FIG. 5, the first and second portions of the solids-containing stream in conduits 526a and 526b are passed through two parallel sets of individual filtration devices 582a,b and 582c,d, which are each arranged in series. Each of filtration devices 582a-d are shown in FIG. 5 as comprising cross-flow filtration devices, which are configured to remove a portion of the liquid phase as a solids-depleted permeate stream and to concentrate the solids into a solids-enriched retentate stream. As generally shown in FIG. 5, the feed stream passing through each of filtration device 582a-d passes in a direction generally parallel to the filter surface 583a-d. This is in contrast to most dead-end filters, which permit the steam being filtered to pass through the filter in a direction generally perpendicular to the filter surface.

As shown in FIG. 5, the concentrated solids-enriched retentate streams withdrawn from filtration devices 582a and 582c via respective conduits 528a and 528b can then be passed as feed streams to successive filtration devices 582b and 582d. The solids-enriched retentate streams from conduits 528a and 528b can then be further concentrated by passage through filtration devices 582c and 582d to provide further concentrated solids-enriched retentate streams in conduits 530a and 530b and two additional solids-depleted permeate streams in conduits 536b and 536d. These further enriched solids-enriched retentate streams in conduits 530a and 530b can then be combined and the combined solids-enriched retentate stream in conduit 532 may be routed to back to the wash zone for further washing or it may be passed to a downstream separation zone (not shown in FIG. 5) once the wash step is complete. Each of the solids-depleted permeate streams in conduits 536a-d may also be combined and routed to a location at or upstream of the wash zone, including one or more intermediate hold tanks (not shown in FIG. 5), as also discussed previously, for use in the current or a future wash cycle. Optionally, one or more of filter elements 582a-d may be backwashed via a back wash fluid, shown by dashed lines 541a-d, which can be passed to the permeate side of filter elements 582a-d via backwash pressure vessels 540a-d, as shown in FIG. 5.

Referring again to FIG. 1, upon completion of the contacting step in wash zone 30, a washed particle slurry comprising a plurality of washed poly(vinyl acetal) resin particles and at least a portion of the wash liquid, can be removed from wash zone 30 via conduit 124. In some embodiments, at least a portion, or substantially all, of the washed poly(vinyl acetal) resin slurry may have passed through a filter 62 and may be into separation zone 40 via conduit 136b, optionally after combination with a washed poly(vinyl acetal) resin slurry withdrawn from wash zone 30 via conduit 124a, if present. In some embodiments, the washed particle slurry introduced into separation zone 40 via conduit 139 can have a total solids content similar to the total solids content of the reaction or diluted reaction slurry introduced into wash zone 130 in conduit 120. For example, the total solids content of the washed particle slurry in conduit 139 can be at least about 0.5, at least about 1, at least about 2, at least about 2.5, at least about 5, at least about 8, at least about 10, at least about 12 and/or not more than about 30, not more than about 25, not more than about 20, not more than about 18, not more than about 10, not more than about 8, not more than about 5, or not more than about 3 weight percent. The total solids content of the washed particle slurry in conduit 139 can be in the range of from about 0.5 to about 30, about 1 to about 25, about 5 to about 20, or about 8 to about 18 weight percent.

The temperature of the washed particle slurry in conduit 139 can be substantially cooler than the reaction slurry or diluted reaction slurry introduced into wash zone 30 and may be, for example, at least about 15, at least about 20, at least about 25, at least about 30 and/or not more than about 60, not more than about 50, not more than about 45, not more than about 40, or not more than about 35° C., or it may be in the range of from about 15 to about 50, about 20 to about 45, or about 25 to about 40° C. As shown in FIG. 1, the washed particle slurry in conduit 139, which may optionally be combined with a yet-to-be-discussed stream in conduit 150, can be introduced into a separation zone 40. In some embodiments, at least a portion of the washed slurry stream in conduit 124a may be directed via conduit 124b to a yet-to-be-discussed reslurry tank 68 and combined with a liquid stream in conduit 151. The resulting solids-containing stream in conduit 150 may then be combined with the stream in conduit 139 before being introduced into separation zone 40. Optionally, in some embodiments, facility 10 can include at least one buffer tank (not shown in FIG. 1) positioned between wash zone 30 and separation zone 40. When present, the buffer tank may help facilitate transfer of the washed slurry from wash zone 30, which may be operated in a batch mode, to separation zone 40, which may be operated in a continuous mode. According to such embodiments, the buffer tank can be configured to receive washed slurry from conduit 124a, 136b, and/or 150, and to discharge slurry into separation zone 40 via conduit 139.

Separation zone 40 can include one or more solid-liquid separation devices capable of separating at least about 20, at least about 30, at least about 40, at least about 50, at least about 60, at least about 70, or at least about 80 percent of the total amount of liquid from the washed poly(vinyl acetal) resin particles. Examples of suitable solid-liquid separation devices can include, but are not limited to, gravity separators, centrifuges, belt filters, vacuum filters, and combinations thereof. The separation may be performed in a single vessel or multiple vessels, arranged in series or in parallel, and may be carried out under any suitable operating conditions.

The resulting substantially dewatered, solids-rich material withdrawn from separation zone 40 via conduit 128 can have a total solids content of at least about 50, at least about 55, at least about 60, or at least about 65 weight percent. Depending on the solids content, a screw conveyor or other such device may be needed to remove the solids-rich material from separation zone 40. In some embodiments, the solids-rich material in conduit 128 can comprise at least about 50, at least about 60, at least about 70, at least about 75, at least about 80, at least about 85, or at least about 90 percent of the total amount of solids introduced into separation zone 40 via conduit 139.

As shown in FIG. 1, a stream of liquid separated from the solids-rich material may be withdrawn from separation zone 40 via conduit 140. In some embodiments, the separated liquid stream may also be passed through at least one filtration device, shown in FIG. 1 as filter 64 upon removal from separation zone 40. The filtration device can be any suitable device for separating at least a portion of the solids from the separated liquid stream in conduit 140. In some embodiments, the filtration device may include one or more filter elements or filters, arranged in series or in parallel, and may comprise at least one cross-flow filter or filter element. One or more characteristics described above with respect to interior filter element 60 and/or external filter 62 as shown in FIG. 1 and/or filter element 280 and filter 282 shown in FIG. 2 may also be applicable to filter 64 shown in FIG. 1.

As shown in FIG. 1, filter 64 is configured to separate the solids-containing feed stream in conduit 140 into a solids-enriched retentate stream in conduit 142 and a solids-depleted permeate stream in conduit 144. In some embodiments, the solids-enriched retentate stream can have a total solids content of at least about 2, at least about 5, at least about 10, at least about 15 and/or not more than about 50, not more than about 40, or not more than about 30 weight percent, or it can be in the range of from about 2 to about 50, about 5 to about 40, or about 10 to about 30 weight percent. The solids-depleted permeate stream in conduit 144 may have a total solids content of not more than about 10, not more than about 5, not more than about 2, not more than about 1, not more than about 0.5, or not more than about 0.1 weight percent. The average particle size of the solids present in the solids-depleted permeate stream is not more than about 40, not more than about 30, not more than about 20, not more than about 15, or not more than about 10 microns.

According to some embodiments, the solids-depleted permeate stream in conduit 144 can be reintroduced into the process at a location at or upstream of separation zone 40. As shown in FIG. 1, at least a portion of the solids-depleted permeate stream in conduit 144 may be combined with the wash liquid in conduit 122 and introduced into wash zone 30. Optionally, all or a portion of the solids-depleted permeate stream in conduit 144 may be temporarily stored in at least one intermediate hold tank, shown as tank 66 in FIG. 1, prior to being combined with the wash liquid in conduit 122. In some embodiments, tank 66 may be an unagitated tank and may not include any sort of mechanical agitation device.

As shown in FIG. 1, at least a portion of the solids-enriched retentate stream withdrawn from filter 64 via conduit 142 may be routed via conduit 148 and can be recombined with the washed particle slurry introduced into separation zone 40 via conduits 148a and 150. Additionally, or in the alternative, all or a portion of the solids-enriched retentate stream in conduit 148 may be introduced into a reslurry tank 68 via conduit 148b and combined with a liquid stream in conduit 151 to produce a reslurried solid stream. In some embodiments, the reslurried stream in conduit 150 can be combined with the washed particle stream from wash zone 30 via conduit 124, when present, and the combined stream may be introduced into separation zone 40. In some embodiments, as discussed previously, the washed particle stream in conduit 124 may pass through reslurry tank 68 and may enter separation zone 40 via conduits 150 and 139. The solids content of the reslurried stream in conduit 150 and/or the solids-containing stream in conduit 139 can be similar to that of the washed particle slurry described herein.

In some embodiments, all or a portion of the solids-enriched retentate stream in conduit 142 may be passed via conduit 152 to another filtration device, shown as filter 68 in FIG. 1, wherein the solids-rich material in conduit 152 may be further concentrated to form a further solids-enriched retentate phase in conduit 156 and another solids-depleted permeate stream in conduit 154. The solids-depleted permeate stream in conduit 154 may be routed to disposal, or may be reintroduced into one or more locations within the process at or upstream of separation zone 40 (not shown in FIG. 1). At least a portion of the further concentrated solids-rich material in conduit 156, which may have a total solids content of at least about 50, at least about 60, at least about 70, or at least about 80 weight percent, may be combined with at least a portion of the solids-rich material withdrawn from separation zone 40 via conduit 128 and the combined material can be introduced into drying zone 50, as shown in FIG. 1.

Drying zone 50 may include one or more driers suitable for further drying the solids-rich material to form a plurality of dried poly(vinyl acetal) resin particles. In some embodiments, drying zone 50 can include a continuous drier such as a fluidized bed dryer, a circulating fluidized bed drier, or a flash drier, although any suitable drier may be used. Drying zone 50 may be operated under any suitable conditions in order to remove as much liquid as possible from the poly(vinyl acetal) resin particles. When removed from drying zone 50 via conduit 160, the dried poly(vinyl acetal) resin particles may have a total liquid content of not more than about 5, not more than about 4, not more than about 3, not more than about 2 not more than about 1 weight percent.

In various embodiments, the poly(vinyl acetal) resin particles can comprise particles of polyvinyl n-butyral (PVB) resin. For example, the poly(vinyl acetal) resin forming the particles may comprise residues of n-butyraldehyde, and may, for example, include not more than about 50, not more than about 40, not more than about 30, not more than about 20, not more than about 10, not more than about 5, or not more than about 2 weight percent of residues of an aldehyde other than n-butyraldehyde, based on the total weight of all aldehyde residues of the resin. When the poly(vinyl acetal) resin comprises a PVB resin, the molecular weight of the resins can be at least about 50,000, at least about 70,000, at least about 100,000 Daltons and/or not more than about 600,000, not more than about 550,000, not more than about 500,000, not more than about 450,000, or not more than about 425,000 Daltons, measured by size exclusion chromatography using a low angle laser light scattering (SEC/LALLS) method. As used herein, the term “molecular weight” refers to weight average molecular weight (M_{w}). The molecular weight of the poly(vinyl acetal) resin can be in the range of from about 50,000 to about 600,000, about 70,000 to about 450,000, or about 100,000 to about 425,000 Daltons.

In some embodiments, the poly(vinyl acetal) resin in the solid particles formed as described herein can have a residual hydroxyl content and an residual acetate content within one or more ranges provided herein. As used herein, the terms “residual hydroxyl content” and “residual acetate content” refer to the amount of hydroxyl and acetate groups, respectively, that remain on a resin after processing is complete. For example, polyvinyl n-butyral can be produced by hydrolyzing polyvinyl acetate to polyvinyl alcohol, and then acetalizing the polyvinyl alcohol with n-butyraldehyde to form polyvinyl n-butyral. In the process of hydrolyzing the polyvinyl acetate, not all of the acetate groups are converted to hydroxyl groups, and residual acetate groups remain on the resin. Similarly, in the process of acetalizing the polyvinyl alcohol, not all of the hydroxyl groups are converted to acetal groups, which also leaves residual hydroxyl groups on the resin. As a result, most poly(vinyl acetal) resins include both residual hydroxyl groups (as vinyl hydroxyl groups) and residual acetate groups (as vinyl acetate groups) as part of the polymer chain. The residual hydroxyl content and residual acetate content are expressed in weight percent, based on the weight of the polymer resin, and are measured according to ASTM D-1396, unless otherwise noted.

In some embodiments, the resin used to form the poly(vinyl acetal) resin particles described herein can have a residual hydroxyl content of at least about 14, at least about 14.5, at least about 15, at least about 15.5, at least about 16, at least about 16.5, at least about 17, at least about 17.5, at least about 18, at least about 18.5, at least about 19, at least about 19.5 and/or not more than about 45, not more than about 40, not more than about 35, not more than about 33, not more than about 30, not more than about 27, not more than about 25, not more than about 22, not more than about 21.5, not more than about 21, not more than about 20.5, or not more than about 20 weight percent, or in the range of from about 14 to about 45, about 16 to about 30, about 18 to about 25, about 18.5 to about 20, or about 19.5 to about 21 weight percent.

In other embodiments, the poly(vinyl acetal) resin can have a residual hydroxyl content of at least about 8, at least about 9, at least about 10, at least about 11 weight percent and/or not more than about 16, not more than about 14.5, not more than about 13, not more than about 11.5, not more than about 11, not more than about 10.5, not more than about 10, not more than about 9.5, or not more than about 9 weight percent, or in the range of from about 8 to about 16, about 9 to about 15, or about 9.5 to about 14.5 weight percent.

The residual acetate content of the poly(vinyl acetal) resin present in the solid particles formed as described herein can be, for example, not more than about 25, not more than about 20, not more than about 15, not more than about 12, not more than about 10, not more than about 8, not more than about 5, not more than about 2, or not more than about 1 weight percent, and/or the poly(vinyl acetal) resin can have an acetate content of at least about 1, at least about 2, at least about 3, at least about 5, at least about 10, at least about 12, or at least about 15 weight percent.

Poly(vinyl acetal) resin formed by processes and systems described herein may be used in a variety of applications. In some embodiments, the poly(vinyl acetal) resin may be used to form a polymer sheet, which may be used, for example, in automobile and architectural safety glass or in photovoltaic modules. As used herein, the term “polymer sheet” refers to any thermoplastic polymer composition formed by any suitable method into a thin layer that is suitable alone, or in multiple layer configuration, for use as a polymeric interlayer in various applications.

Resin sheets formed using poly(vinyl acetal) resin particles described above may further include at least one plasticizer. In some embodiments, the plasticizer may be present in an amount of at least about 5, at least about 10, at least about 15, at least about 20, at least about 25, at least about 30, at least about 35, at least about 40, at least about 45, at least about 50, at least about 55, at least about 60 parts per hundred parts of resin (phr) and/or not more than about 120, not more than about 110, not more than about 105, not more than about 100, not more than about 95, not more than about 90, not more than about 85, not more than about 75, not more than about 70, not more than about 65, not more than about 60, not more than about 55, not more than about 50, not more than about 45, or not more than about 40 phr, or in the range of from about 5 to about 120, about 10 to about 110, about 20 to about 90, or about 25 to about 75 phr. As used herein, the term “parts per hundred parts of resin” or “phr” refers to the amount of plasticizer present as compared to one hundred parts of resin, on a weight basis.

Examples of suitable plasticizers can include, but are not limited to, triethylene glycol di-(2-ethylhexanoate) (“3GEH”), triethylene glycol di-(2-ethylbutyrate), triethylene glycol diheptanoate, tetraethylene glycol diheptanoate, tetraethylene glycol di-(2-ethylhexanoate) (“4GEH”), dihexyl adipate, dioctyl adipate, hexyl cyclohexyladipate, diisononyl adipate, heptylnonyl adipate, di(butoxyethyl) adipate, and bis(2-(2-butoxyethoxy)ethyl) adipate, dibutyl sebacate, dioctyl sebacate, and mixtures thereof. The plasticizer may be selected from the group consisting of triethylene glycol di-(2-ethylhexanoate) and tetraethylene glycol di-(2-ethylhexanoate), or the plasticizer can comprise triethylene glycol di-(2-ethylhexanoate).

The polymer sheets may also include at least one additive for imparting particular properties or features to the interlayer. Such additives can include, but are not limited to, dyes, pigments, stabilizers such as ultraviolet stabilizers, antioxidants, anti-blocking agents, flame retardants, IR absorbers or blockers such as indium tin oxide, antimony tin oxide, lanthanum hexaboride (LaB₆) and cesium tungsten oxide, processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers. Additionally, the polymer sheets may also include various adhesion control agents (“ACAs”) can be used in the interlayers of the present disclosure to control the adhesion of the sheet to glass. Suitable ACAs can include, but are not limited to, sodium acetate, potassium acetate, magnesium bis(2-ethyl butyrate), magnesium bis(2-ethylhexanoate), and combinations thereof.

The resin sheets formed from particles as described herein may be formed according to any suitable method. Exemplary methods of forming polymer sheets can include, but are not limited to, solution casting, compression molding, injection molding, melt extrusion, melt blowing, and combinations thereof. Multilayer interlayers including two or more resin sheets may also be produced according to any suitable method such as, for example, co-extrusion, blown film, melt blowing, dip coating, solution coating, blade, paddle, air-knife, printing, powder coating, spray coating, and combinations thereof. In various embodiments of the present invention, the layers or interlayers may be formed by extrusion or co-extrusion. The thickness, or gauge, sheets can be at least about 10, at least about 15, at least about 20 mils and/or not more than about 100, not more than about 90, not more than about 60, not more than about 50, or not more than about 35 mils, or it can be in the range of from about 10 to about 100, about 15 to about 60, or about 20 to about 35 mils. In millimeters, the thickness can be at least about 0.25, at least about 0.38, at least about 0.51 mm and/or not more than about 2.54, not more than about 2.29, not more than about 1.52, or not more than about 0.89 mm, or in the range of from about 0.25 to about 2.54 mm, about 0.38 to about 1.52 mm, or about 0.51 to about 0.89 mm.

The resulting resin sheet may be utilized in a multiple layer panel that comprises a resin layer or interlayer and at least one rigid substrate. Any suitable rigid substrate may be used and in some embodiments may be selected from the group consisting of glass, polycarbonate, biaxially oriented PET, copolyesters, acrylic, and combinations thereof. The panels can be used for a variety of end use applications, including, for example, for automotive windshields and windows, aircraft windshields and windows, panels for various transportation applications such as marine applications, rail applications, etc., structural architectural panels such as windows, doors, stairs, walkways, balusters, decorative architectural panels, weather-resistant panels, such as hurricane glass or tornado glass, ballistic panels, and other similar applications.

The following examples are intended to be illustrative of the present invention in order to teach one of ordinary skill in the art to make and use the invention and are not intended to limit the scope of the invention in any way.

### EXAMPLES

### Example 1

### Filtration Performance for Various Filter Elements with a PVB Slurry

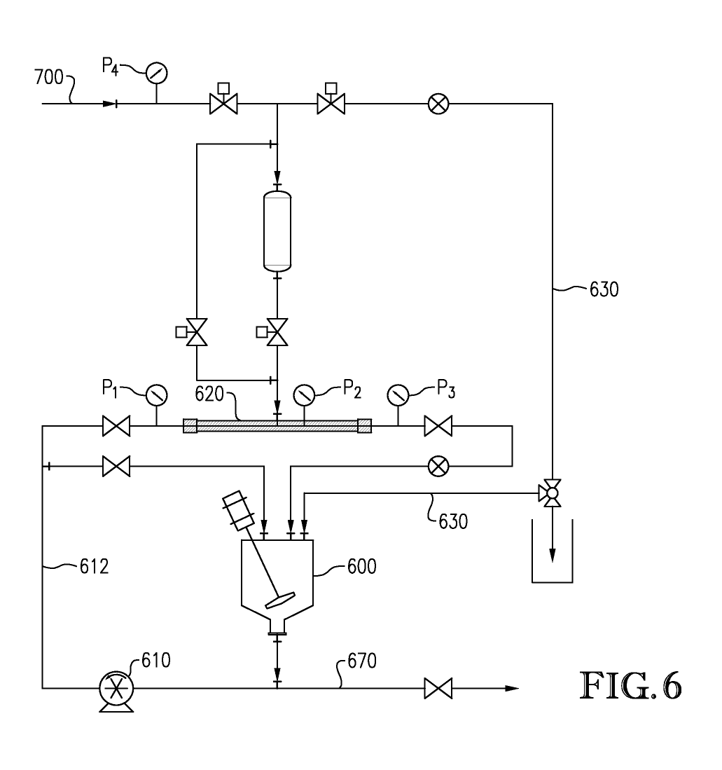

The permeate flux of several filtration devices was determined according to the following procedure. An experimental set up as shown in FIG. 6 was constructed. The set up included an agitated reaction vessel 600, a positive displacement pump 610, a feed slurry line 612, a cross-flow filtration device 620, a filtrate recirculation line 660, and a concentrated slurry line 670. As poly(vinyl alcohol) and butyraldehyde were reacted within agitated reaction vessel 600, the PVB resin precipitated and the resulting aqueous slurry was transported from reaction vessel 600 to filtration device 620 via slurry line 650. Various pressure transducers (P1 through P4) and several valves were also included, as shown in FIG. 6. Filtration device 620 included a single, 2-foot long cross-flow filter element having an internal diameter of ⅜ inch. The total flow area of filtration device 620 was 0.19 ft².

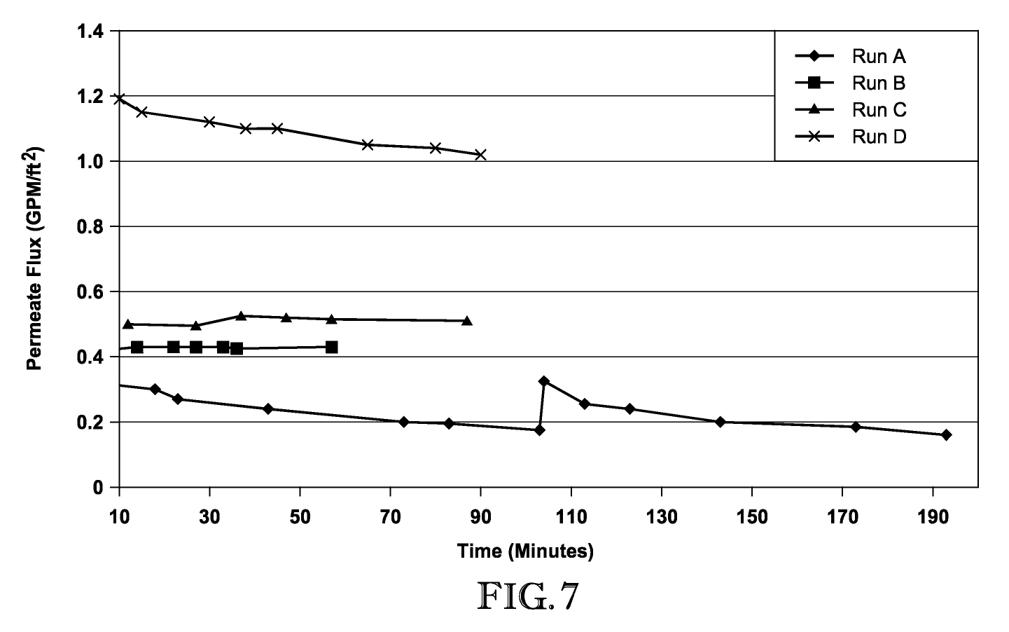

Several trials were conducted using the apparatus shown in FIG. 6 at varying slurry flow rates and/or using differently-sized filter elements. The conditions for these trials are summarized in Table 1, below, and the permeate flux across the filtration surface for each run, as a function of time, is graphically summarized in FIG. 7. The inlet, outlet, and transmembrane pressures were measured using pressure transducers available from Omega Engineering, Inc., and filtrate quality was measured using a turbidimeter available from Hach Company. Filtration device 620 back-pulsed only once during Run A, as described below.

TABLE 1
Conditions of Several Filtration Trials of Aqueous
PVB Resin Slurry

| Experimental | Flow Rate | Filter Element Size |
|---|---|---|
| Run | (gpm) | (μm) |
| Run A | 1.5 | 2 |
| Run B | 2.6 | 2 |
| Run C | 3 | 5 |
| Run D | 3.2 | 10 |

As shown in FIG. 7, a fairly constant permeate flux can be maintained, even without back-pulsing when, for example, a 2-micron filter element is used with a slurry flow rate of 2.6 gpm (Run B) or a 5-micron filter element is used at a 3 gpm slurry flow (Run C). A gradual drop in permeate flux was observed when, for example, a 1.5 gpm slurry flow rate was used with the 2-micron filter element (Run A) and when a 3.2 gpm flow rate was used with a 10-micron filter element (Run D), as also shown in FIG. 7. In the case of a drop in permeate flux, a simple back-pulse may be useful, as evidenced by the rapid increase in permeate flux following a back pulse shown in Run A at 110 minutes. Overall, FIG. 7 demonstrates that sustainable operation of a cross-flow filter element, with little or no back-pulsing, can be used with aqueous slurries of poly(vinyl acetal) resin particles.

### Example 2 (Prophetic)

### Simulation of a Multiple-Stage Filtration Device

The operation of a multiple-stage filtration system suitable for concentrating a poly(vinyl n-butyral) resin slurry is simulated in the following prophetic example. An aqueous poly(vinyl n-butyral) slurry, which has a solids content of 1 weight percent, is passed through a 7-stage cross-flow filtration device. The final filtrate withdrawn from the system has a solids content of 17.2 weight percent. Each stage employs at least one tubular 3/8-inch (ID) filter element, and the minimum velocity of the slurry through each of the filtration stages is 5 ft/s.

Table 2, below, summarizes key parameters for each stage of the filtration system, including filtration area, feed and exit flow rate, velocity, and concentration, and permeate flow rate, simulated as above.

TABLE 2
Key Parameters for Multiple Stage Filtration Device

| | Stage Number | | | | | | |
|---|---|---|---|---|---|---|---|
| Parameter | 1 | 2 | 3 | 4 | 5 | 6 | 7 |
| Number of Filter | 21 | 14 | 9 | 5 | 4 | 2 | 2 |
| Elements | | | | | | | |
| Filtration Area (ft²) | 20.62 | 13.75 | 8.84 | 4.91 | 3.93 | 1.96 | 1.57 |
| Feed Flow Rate (gpm) | 59.00 | 38.38 | 24.64 | 15.80 | 10.89 | 6.97 | 5.00 |
| Feed Velocity (ft/s) | 8.19 | 7.99 | 7.98 | 9.21 | 7.94 | 10.15 | 7.29 |
| Feed Solids Content | 1.00 | 1.54 | 2.39 | 3.73 | 5.42 | 8.47 | 11.80 |
| (wt %) | | | | | | | |
| Permeate Flow Rate | 20.62 | 13.75 | 8.84 | 4.91 | 3.93 | 1.96 | 1.57 |
| (gpm) | | | | | | | |
| Exit Flow Rate (gpm) | 38.38 | 24.64 | 15.80 | 10.89 | 6.7 | 5.00 | 3.43 |
| Exit Velocity (ft/s) | 5.33 | 5.13 | 5.12 | 6.35 | 5.08 | 7.29 | 5.00 |
| Exit Solids Content | 1.54 | 2.39 | 3.73 | 5.42 | 8.47 | 11.80 | 17.20 |
| (wt %) | | | | | | | |

### Example 3

### Effects of In-Line Dilution on PVB Production Process

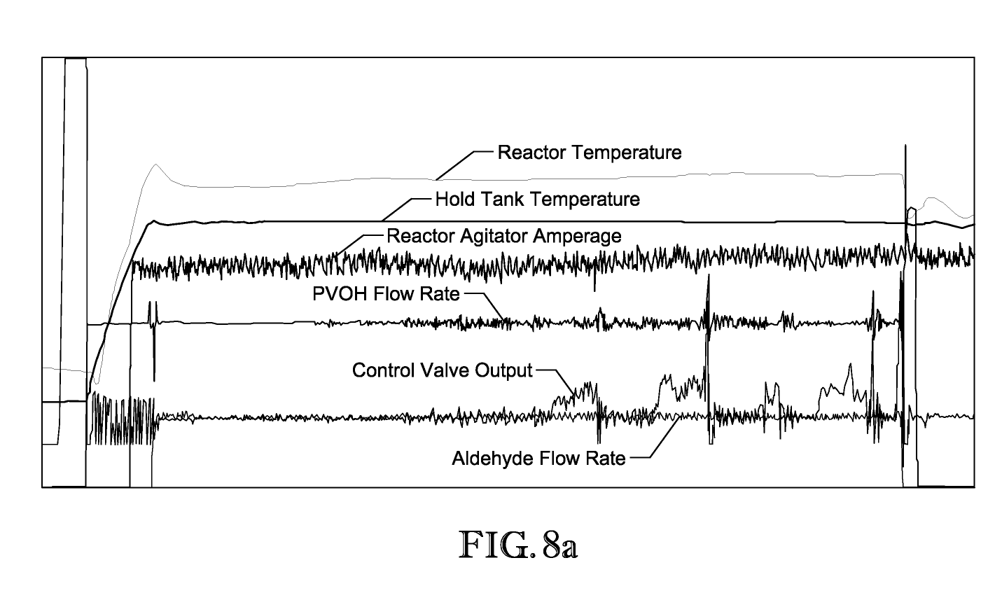

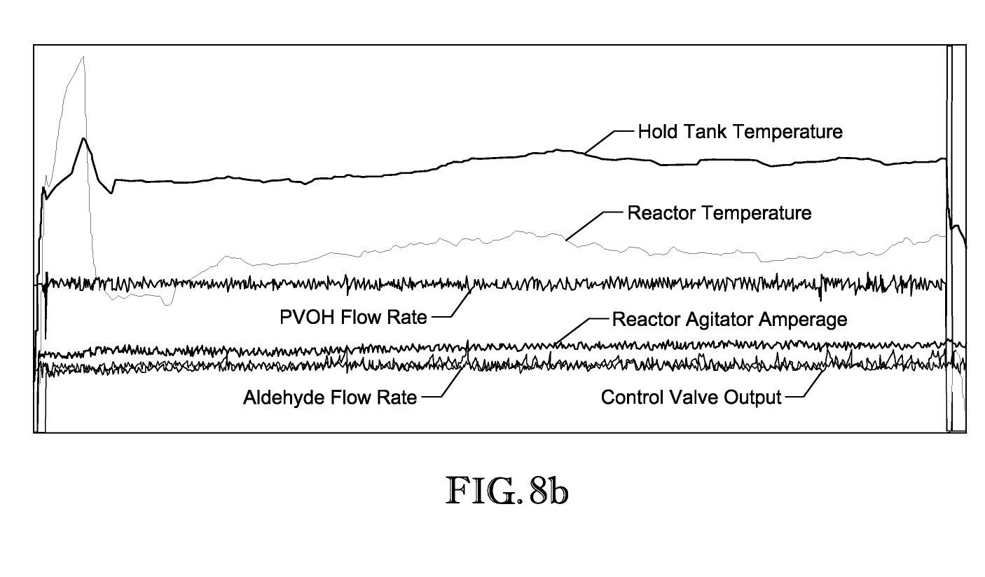

A resin production process including a reaction vessel, a wash vessel, and an interim holding tank was used to produce PVB. Several process parameters, including reactor temperature, hold tank temperature, amperage of the reaction agitator, and the flow of each reactant stream, were monitored using an online control system and the value of each of these parameters was graphed as a function of time, along with the output of the flow control valve disposed between the reaction vessel and the hold tank, which indicated the opening or closing of the valve. In the Comparative Case shown in FIG. 8a, the reactor effluent stream was routed directly from the reaction vessel to the hold tank, while, in the Disclosed Case shown in FIG. 9b, a stream of dilution fluid was added to the reactor effluent upstream of the control valve and the combined stream was introduced into the hold tank.

The addition of a dilution stream to the reactor effluent upstream of the control valve had three main effects on the system. First, it reduced the slurry temperature in the hold tank, which may help decrease the “stickiness” and agglomeration tendency of the particles. Next, it reduced the concentration of solids in the reactor effluent, which may reduce the likelihood of agglomeration. Finally, the use of in-line dilution stabilized the reactor effluent flow without requiring a change in line size or a reduction in velocity. Further, as shown by a comparison of FIGS. 8a and 8b, in-line dilution of the reaction vessel effluent resulted in more stabilized operation of the flow control valve between the reaction vessel and the hold tank.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, an interlayer can be formed comprising poly(vinyl butyral) having a residual hydroxyl content in any of the ranges given in addition to comprising a plasticizers in any of the ranges given to form many permutations that are within the scope of the present disclosure, but that would be cumbersome to list. Further, ranges provided for a genus or a category, such as phthalates or benzoates, can also be applied to species within the genus or members of the category, such as dioctyl terephthalate, unless otherwise noted.

What is claimed is:

1. A process for producing a poly(vinyl acetal) resin, said process comprising:
(a) reacting a poly(vinyl alcohol) with at least one aldehyde to produce a reaction slurry comprising a plurality of poly(vinyl acetal) resin particles;
(b) contacting at least a portion of said poly(vinyl acetal) resin particles with a wash liquid to thereby provide a plurality of washed particles and a spent wash liquid;
(c) withdrawing at least a portion of said washed particles and spent wash liquid from said wash vessel as a solids-containing slurry;
(d) passing a portion of said solids-containing slurry through at least one filtration device to thereby provide a solids-enriched retentate stream and a solids-depleted permeate stream, wherein said passing increases the concentration of solids in said solids-enriched retentate stream as compared to the solids content of said solids-containing slurry introduced into said filtration device; and
(d) reintroducing at least a portion of said solids-enriched retentate stream back into said process at a location at or downstream of said contacting step.

2. The process of claim 1, wherein said passing is performed continuously and wherein the average cross-flow velocity of said portion of said solids-containing slurry passing through said filtration device is at least 0.5 ft/s, and wherein the maximum cross-membrane pressure drop is not more than 10 psi/ft².

3. The process of claim 1, wherein the difference between the total solids content of said solids-enriched retentate stream and said portion of said solids-containing slurry introduced into said filtration device is not more than 5 weight percent.

4. The process of claim 1, wherein said solids-enriched retentate stream comprises at least 60 percent of the total amount of solids present in said portion of said solids-containing slurry introduced into said filtration device.

5. The process of claim 1, wherein said filtration device is a multi-stage filtration device comprising two or more filtration stages.

6. The process of claim 1, further comprising, passing at least a portion of said washed particles and/or said spent wash liquid within said wash vessel through at least one filtration device located within the interior of said wash vessel to provide a solids-enriched retentate phase and a solids-depleted permeate phase, wherein at least a portion of said solids-depleted permeate phase is withdrawn from said wash vessel.

7. The process of claim 1, further comprising reintroducing at least a portion of said solids-depleted permeate stream back into said process at a location at or upstream of said contacting step.

8. The process of claim 1, wherein during at least a portion of said passing, the average temperature of said solids-containing slurry introduced into said filtration device is at least 40° C.

9. A process for producing a poly(vinyl acetal) resin, said process comprising:
(a) introducing a reaction slurry comprising a plurality of poly(vinyl acetal) resin particles into a wash vessel;
(b) contacting at least a portion of said poly(vinyl acetal) resin particles in said wash vessel via contact with at least one wash liquid;
(c) removing a solids-containing slurry from said wash vessel;
(d) passing at least a portion of said solids-containing slurry through at least one filtration element to provide a solids-enriched stream and a solids-depleted stream; and
(e) recovering at least a portion of the poly(vinyl acetal) resin solids in said solids-enriched stream.

10. The process of claim 9, wherein the difference between the total solids content of said solids-containing slurry and the total solids content of said solids-enriched slurry is not more than 5 weight percent.

11. The process of claim 9, wherein said solids-containing slurry has a total solids content of at least 5 weight percent, based on the total weight of the stream, and said solids-depleted stream has a total solids content of less than 1 weight percent, based on the total weight of the stream.

12. The process of claim 11, wherein the average particle size of the poly(vinyl acetal) resin particles present in said solids-depleted stream is less than 30 microns.

13. The process of claim 9, wherein the average permeate flux across said filtration element is at least 0.2 gpm/ft².

14. The process of claim 9, wherein the temperature of said reaction slurry introduced into said wash vessel is at least 60° C.

15. The process of claim 9, wherein said poly(vinyl acetal) resin particles comprise poly(vinyl n-butyral) resin particles and wherein, during at least a portion of said passing, the average temperature of said slurry passed through said filtration element is at least 40° C.

16. The process of claim 9, further comprising reintroducing at least a portion of said solids-enriched stream into said wash vessel, and wherein said recovering comprises separating at least a portion of the washed poly(vinyl acetal) resin particles from at least a portion of said wash liquid in a solid-liquid separator to provide a solids-enriched material, and drying said solids-enriched material in a dryer to provide dried resin particles.

17. A system for producing a poly(vinyl acetal) resin, said system comprising:
a reaction vessel for reacting a poly(vinyl alcohol) and at least one aldehyde to form a reaction slurry comprising solid poly(vinyl acetal) resin particles, wherein said reaction vessel comprises at least one reactor inlet and at least one reactor outlet;
a wash vessel for receiving at least a portion of said reaction slurry from said reaction vessel and for contacting at least a portion of said poly(vinyl acetal) resin particles with a wash liquid, wherein said wash vessel comprises a slurry inlet, a slurry outlet, a wash fluid inlet, and a wash fluid outlet;
a wash liquid line for introducing said wash liquid into said wash vessel, wherein said wash liquid line is in fluid flow communication with said wash fluid inlet of said wash vessel;
a washed slurry line for removing at least a portion of the solids-containing washed slurry from the wash vessel, wherein said washed slurry line is in fluid flow communication with said slurry outlet of said wash vessel; and
at least one filtration device external to said wash vessel for removing at least a portion of said poly(vinyl acetal) resin particles from the washed slurry, wherein said filter element comprises a fluid inlet, a solids-enriched fluid outlet, a solids-depleted fluid outlet, and at least one filter surface, wherein said fluid inlet of said filtration device is in fluid flow communication with said slurry outlet of said wash vessel via said washed slurry line, and wherein said filter surface is disposed between said fluid inlet and said solids-depleted fluid outlet within said filtration device, wherein said filter surface is oriented generally parallel to the direction of flow of said washed slurry as it passes from said fluid inlet to said solids-enriched fluid outlet in said filtration device.

18. The system of claim 17, further comprising an agitation device at least partially disposed within said wash vessel, wherein said agitation device comprises at least one impeller and is configured to agitate said reaction slurry within said wash vessel.

19. The system of claim 17, further comprising at least one filter element disposed within the interior of said wash vessel for removing at least a portion of said poly(vinyl acetal) resin particles from the spent wash liquid, wherein said filter element is disposed between and in fluid flow communication with said interior of said wash vessel and said wash fluid outlet.

20. The system of claim 17, wherein said filtration device comprises two or more filter elements.
